(19) United States
(12) Patent Application Publication
(10) Pub. No.: US 2021/0286297 A1
(43) Pub. Date: Sep. 16, 2021

(54) IMAGE FORMING APPARATUS

(71) Applicant: Satoshi KUNO, Tokyo (JP)

(72) Inventor: Satoshi KUNO, Tokyo (JP)

(73) Assignee: Ricoh Company, Ltd.

(21) Appl. No.: 17/197,088

(22) Filed: Mar. 10, 2021

(30) Foreign Application Priority Data
Mar. 11, 2020 (JP) 2020-041906

(51) Int. Cl. G03G 15/20

(52) U.S. Cl. CPC G03G 15/2028

(57) ABSTRACT

An image forming apparatus includes a liquid applier, a heating device, and circuitry. The liquid applied is configured to apply liquid to a conveyance target object that is conveyed at a first speed. The heating device is configured to heat the conveyance target object on which the liquid is applied. The circuitry is configured to control a conveying speed of the conveyance target object. The circuitry is configured to cause the conveyance target object to be conveyed at a second speed that is faster than the first speed after the liquid applier applies the liquid to the conveyance target object.

### CROSS-REFERENCE TO RELATED APPLICATION

This patent application is based on and claims priority pursuant to 35 U.S.C. § 119(a) to Japanese Patent Application No. 2020-041906, filed on Mar. 11, 2020, in the Japan Patent Office, the entire disclosure of which is hereby incorporated by reference herein.

### BACKGROUND

### Technical Field

Embodiments of the present disclosure relate to an image forming apparatus.

### Background Art

Various types of image forming apparatuses, i.e., copiers and printers, are known to include a heating device to heat a conveyance target object such as a sheet on which liquid is applied while conveying the conveyance target object.

For example, a known inkjet image forming apparatus heats a sheet on which surface encapsulant for preventing image deterioration is applied while holding the sheet. In the known inkjet image forming apparatus, after ink is discharged to the sheet, a pair of rollers that are heated conveys the sheet while holding the sheet, so that the surface encapsulant on the sheet melts by heat. Thereafter, as the sheet is ejected from between the pair of rollers, the surface encapsulant is naturally cooled to be cured.

### SUMMARY

At least one aspect of this disclosure, a novel image forming apparatus includes a liquid applier, a heating device, and circuitry. The liquid applied is configured to apply liquid to a conveyance target object that is conveyed at a first speed. The heating device is configured to heat the conveyance target object on which the liquid is applied. The circuitry is configured to control a conveying speed of the conveyance target object. The circuitry is configured to cause the conveyance target object to be conveyed at a second speed that is faster than the first speed after the liquid applier applies the liquid to the conveyance target object.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating a schematic configuration of an image forming apparatus according to an embodiment of the present disclosure;

FIG. 2 is a plan view illustrating an image forming device including a serial-type liquid discharge head;

FIG. 3 is a plan view illustrating an image forming device including a line-type liquid discharge head;

FIG. 4 is a diagram illustrating a schematic configuration of a drying device provided in the image forming apparatus of FIG. 1;

FIG. 5 is a plan view illustrating the drying device indicating the arrangement of spur wheels provided in the drying device of FIG. 4;

FIG. 6 is a plan view illustrating the drying device indicating another arrangement of spur wheels;

FIG. 7 is a diagram for explaining a method of controlling a conveying speed;

FIG. 8 is a diagram for explaining the method of controlling the conveying speed, subsequent from FIG. 7;

FIG. 9 is a diagram for explaining the method of controlling the conveying speed, subsequent from FIG. 8;

FIG. 10 is a diagram for explaining the method of controlling the conveying speed, subsequent from FIG. 9;

FIG. 11 is a diagram for explaining the method of controlling the conveying speed, subsequent from FIG. 10;

FIG. 12 is a diagram for explaining the method of controlling the conveying speed, subsequent from FIG. 11;

FIG. 13 is a graph illustrating the changes of a conveying speed in chronological order;

FIG. 14 is a graph illustrating the changes of another conveying speed in chronological order;

FIG. 15 is a graph illustrating the changes of yet another conveying speed in chronological order;

FIG. 16 is a diagram illustrating the conveying operation when sheets are continuously conveyed;

FIG. 17 is a diagram illustrating the conveying operation when sheets are continuously conveyed, subsequent from FIG. 16;

FIG. 18 is a diagram illustrating the conveying operation when sheets are continuously conveyed, subsequent from FIG. 17;

FIG. 19 is a diagram illustrating the conveying operation when the sheet is conveyed to the sheet reverse passage in a duplex printing mode;

FIG. 20 is a diagram illustrating the conveying operation when the sheet is conveyed to the sheet reverse passage in a duplex printing mode, subsequent from FIG. 19;

FIG. 21 is a diagram for explaining the principle of generation of a back curl on a sheet;

FIG. 22 is a diagram for explaining the principle of generation of another back curl on a sheet;

FIG. 23 is a diagram illustrating an example of a pressure roller employing an abrasive roller;

FIG. 24 is a diagram illustrating an example of a pressure roller employing a knurl roller;

FIG. 25 is a diagram illustrating an example that the pressure roller contacts a fixed roller via the heat belt;

FIG. 26 is a diagram illustrating an example that the pressure roller contacts a tension roller and the fixed roller via the heat belt;

FIG. 27 is a diagram illustrating an example of an air blowing fan instead of the spur wheels;

FIG. 28 is a diagram illustrating an example of an air suction fan instead of the spur wheels;

FIG. 29 is a diagram illustrating an example that the winding angle of the heat belt around the pressure roller is changeable;

FIG. 30 is a diagram illustrating an example in which the drying device includes a pressure belt;

FIG. 31 is a diagram illustrating an example that the outer circumferential surface of a pressure belt has fine surface asperities;

FIG. 32 is a diagram illustrating an example that the pressure belt has a mesh pattern;

FIG. 33 is a diagram illustrating an example of the arrangement in which a heater is disposed inside the pressure roller;

FIG. 34 is a diagram illustrating an example of controlling heat generation in each heater so that the opposite face that is opposite a liquid applied face of the sheet is heated at the higher temperature;

FIG. 35 is a diagram illustrating an example in which a first heating member and a second heating member are heat rollers in pair;

FIG. 36 is a diagram illustrating an example in which the first heating member and the second heating member do not contact with each other;

FIG. 37 is a diagram illustrating an example that a rotary body that contacts the first heat roller is a belt;

FIG. 38 is a diagram illustrating an example in which the order of the position of the first heat roller and the position of a second heat roller in a sheet conveyance direction are reversed from the order of the positions illustrated in FIG. 36;

FIG. 39 is a diagram illustrating an example that a ceramic heater is employed to contact the heat belt;

FIG. 40 is a diagram illustrating an example that a ceramic heater is employed to contact the heat belt at the nip region;

FIG. 41 is a diagram illustrating an example that a ceramic heater is employed to contact the pressure belt;

FIG. 42 is a diagram illustrating an example that the heat belt is supported by a belt support that does not rotate;

FIG. 43 is a diagram illustrating an example that the drying device employs a pressing pad that does not rotate;

FIG. 44 is a diagram illustrating an example in which the drying device includes a heat guide;

FIG. 45 is a diagram illustrating a heat guide according to a variation;

FIG. 46 is a cross sectional view illustrating the heat guide of FIG. 45 in the width direction of the sheet;

FIG. 47 is a diagram illustrating the configuration of another image forming apparatus;

FIG. 48 is a diagram illustrating the configuration of yet another image forming apparatus;

FIG. 49 is a diagram illustrating an example of an additional processing device included in an image forming apparatus; and

FIG. 50 is a diagram illustrating another example of an additional processing device attached to in an image forming apparatus.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

Descriptions are given of an example applicable to an image forming apparatus. It is to be noted that elements (for example, mechanical parts and components) having the same functions and shapes are denoted by the same reference numerals throughout the specification and redundant descriptions are omitted.

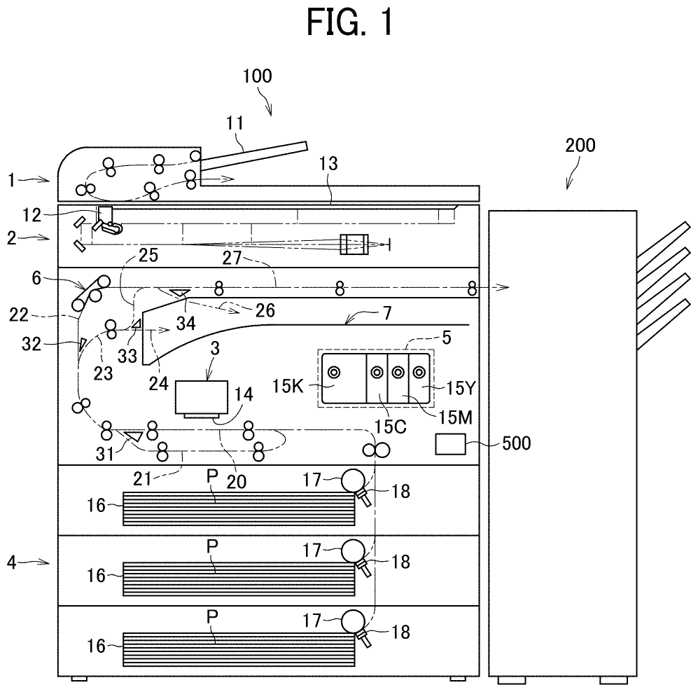

Initially with reference to FIG. 1, a description is given of an image forming apparatus 100 according to an embodiment of the present disclosure.

FIG. 1 is a schematic cross-sectional view of the image forming apparatus 100.

As illustrated in FIG. 1, an image forming apparatus 100 according to the present embodiment includes an original document conveying device 1, an image reading device 2, an image forming device 3, a sheet feeding device 4, a cartridge container 5, a drying device (heating device) 6, and a sheet ejection portion 7. Further, a sheet alignment apparatus 200 is disposed adjacent to and detachably attached to the housing of the image forming apparatus 100. The sheet alignment apparatus 200 may be included in the image forming apparatus 100.

The original document conveying device 1 separates an original document from the other original documents one by one from a set of original documents on an original document tray 11 and conveys the separated original document toward an exposure glass 13 of the image reading device 2. The original document conveying device 1 includes a plurality of conveyance rollers each functioning as an original document conveyor to convey the original document.

The image reading device 2 is an image scanner, that is, a device to scan the image on an original document placed on the exposure glass 13 or the image on an original document as the original document passes over the exposure glass 13. The image reading device 2 includes an optical scanning unit 12 as an image reading unit. The optical scanning unit 12 includes a light source that irradiates an original document placed on the exposure glass 13 with light, and a charge-coupled device (CCD) as an image reader that reads an image from the reflected light of the original document. Further, a close contact-type image sensor (CIS) may be employed as an image reader.

The image forming device 3 includes a liquid discharge head 14 that functions as a liquid applier to apply liquid to a sheet. The liquid discharge head 14 discharges ink that is liquid used for image formation and applies the ink to the sheet. The liquid discharge head 14 may be a serial-type liquid discharge head that discharges ink while moving in the main scanning direction of a sheet (i.e., the sheet width direction) or a line-type liquid discharge head that discharges ink without moving a plurality of liquid discharge heads aligned in the main scanning direction. Note that the detailed configuration of each of the serial-type liquid discharge head 14 and the line-type liquid discharge head 14 will be described below.

Ink cartridges 15Y, 15M, 15C, and 15K are detachably attached to the cartridge container 5. The ink cartridges 15Y, 15M, 15C, and 15K are filled with inks of different colors such as yellow, magenta, cyan, and black, respectively. The ink in each ink cartridge (i.e., the ink cartridges 15Y, 15M, 15C, 15K) is supplied to the liquid discharge head 14 by an ink supply pump.

The sheet feeding device 4 includes a plurality of sheet feed trays 16 each functioning as a sheet container. Each sheet feed tray 16 loads a bundle of sheets including a sheet P. Each sheet P on which an image is formed is a cut sheet cut in a predetermined size, e.g., A4 size and B4 size, and is previously contained in the sheet feed tray 16 in a corresponding sheet conveyance direction. Further, each sheet feed tray 16 includes a sheet feed roller 17 that functions as a sheet feeder and a sheet separation pad 18 that functions as a sheet separator.

The sheet P functions as a conveyance target object and the bundle of sheets functions as a bundle of conveyance target objects.

The sheet alignment apparatus 200 functions as a post-processing apparatus that performs a post-processing operation to align and register the sheets P conveyed from the image forming apparatus 100. Further, in addition to the sheet alignment apparatus 200, another post-processing apparatus such as a stapling device that staples (binds) the sheets and a punching device that punches holes in the sheet may be installed.

To provide a fuller understanding of the embodiments of the present disclosure, a description is now given of the basic image forming operation of the image forming apparatus 100 according to the present embodiment of this disclosure, with continued reference to FIG. 1.

As an instruction is given to start the printing operation, a sheet P is fed from one sheet feed tray 16 of the plurality of sheet feed trays 16. To be more specific, as the sheet feed roller 17 rotates, an uppermost sheet P placed on top of the bundle of sheets P contained in the sheet feed tray 16 is fed by the sheet feed roller 17 and the sheet separation pad 18 while the uppermost sheet P is separated from the other sheets of the bundle of sheets.

When the sheet P is conveyed to a sheet conveyance passage 20 that extends in the horizontal direction and faces the image forming device 3, the image forming device 3 forms an image on the sheet P. To be more specific, the liquid discharge head 14 is controlled to discharge liquid (ink) according to image data of the original document read by the image reading device 2 or print data instructed to print by an external device, so that ink is discharged on the image forming surface (upper face) of the sheet P to form an image. Note that the image to be formed on the sheet P may be a meaningful image such as text or a figure, or a pattern having no meaning per se.

When duplex printing is performed, the sheet P is conveyed in the opposite direction opposite the sheet conveyance direction at a position downstream from the image forming device 3 in the sheet conveyance direction, so that the sheet P is guided to a sheet reverse passage 21. To be more specific, after the trailing end of the sheet P has passed a first passage changer 31 that is disposed downstream from the image forming device 3 in the sheet conveyance direction, the sheet P is conveyed in the opposite direction. Further, after the trailing end of the sheet P has passed the first passage changer 31, the first passage changer 31 changes the sheet conveyance passage of the sheet P to the sheet reverse passage 21. Accordingly, the sheet P is guided to the sheet reverse passage 21. Then, as the sheet P passes through the sheet reverse passage 21, the sheet P is reversed upside down and conveyed to the image forming device 3 again. Then, the image forming device 3 repeats the same operation performed to the front face of the sheet P, so as to form an image on the back face of the sheet P.

A second passage changer 32 is disposed downstream from the first passage changer 31 in the sheet conveyance direction. The second passage changer 32 guides the sheet P with the image selectively to a sheet conveyance passage 22 that runs through the drying device 6 or to a sheet conveyance passage 23 that does not run through the drying device 6. When the sheet P is guided to the sheet conveyance passage 22 through which the sheet P passes the drying device 6, the drying device 6 dries the ink on the sheet P. On the other hand, when the sheet P is guided to the sheet conveyance passage 23 through which the sheet P does not pass the drying device 6, a third passage changer 33 guides the sheet P selectively to a sheet conveyance passage 24 toward the sheet ejection portion 7 or to a sheet conveyance passage 25 toward the sheet alignment apparatus 200. Further, after the sheet P has passed the drying device 6, a fourth passage changer 34 guides the sheet P selectively to a sheet conveyance passage 26 toward the sheet ejection portion 7 or to a sheet conveyance passage 27 toward the sheet alignment apparatus 200.

In a case in which the sheet P is guided to the sheet conveyance passage 24 or the sheet conveyance passage 26 toward the sheet ejection portion 7, the sheet P is ejected to the sheet ejection portion 7 with an image forming surface down. Here, the image forming surface indicates a liquid applied face of the sheet P on which ink is applied. On the other hand, in a case in which the sheet P is guided to the sheet conveyance passage 25 or the sheet conveyance passage 27 toward the sheet alignment apparatus 200, the sheet P is conveyed to the sheet alignment apparatus 200, so that the bundle of sheets P is aligned and stacked. Accordingly, a series of printing operations is completed.

Next, a description is given of the configuration of the serial-type liquid discharge head 14 as an example of the image forming device 3.

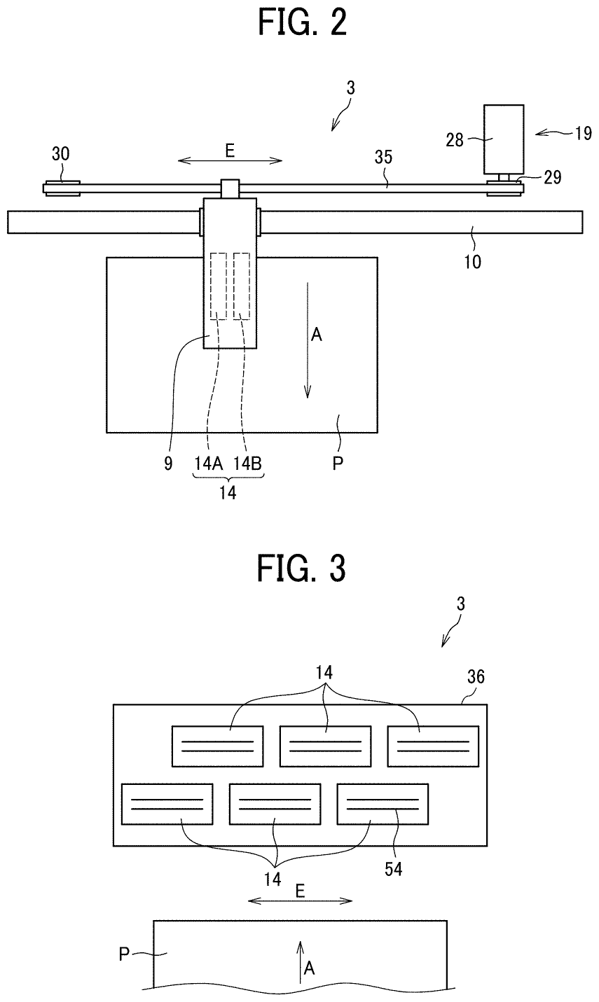

FIG. 2 is a plan view illustrating the image forming device 3 including the serial-type liquid discharge head 14.

As illustrated in FIG. 2, the image forming device 3 includes a carriage 9, a guide (guide rod) 10, and a drive device 19. The carriage 9 is provided with the liquid discharge head 14. The guide 10 guides the carriage 9 in the main scanning direction E that is a sheet width direction of the sheet P.

The liquid discharge head 14 in the present embodiment includes a monochrome liquid discharge head 14A and a color liquid discharge head 14B. The monochrome liquid discharge head 14A includes discharge port rows, from each of which black ink liquid is discharged. The color liquid discharge head 14B includes discharge port rows, from each of which cyan, magenta, and yellow ink liquids are discharged. The monochrome liquid discharge head 14A and the color liquid discharge head 14B are provided on the carriage 9. Each of the monochrome liquid discharge head 14A and the color liquid discharge head 14B has a face on which the discharge port rows are formed, and the face is disposed facing down. In other words, the ink discharge direction of ink from the discharge port rows is downward, so that each of the monochrome liquid discharge head 14A and the color liquid discharge head 14B is disposed in a direction in which each discharge port row intersects with the main scanning direction E. This direction is hereinafter referred to as a sheet conveyance direction A. Note that a liquid discharge head may be provided for each of the different colors. Alternatively, the liquid discharge head may include a head that discharges each of black ink and cyan ink and a head that discharges each of magenta ink and yellow ink. Further, the color of ink to be used in the image forming apparatus 100 is not limited to the above-described colors.

As an energy generator to discharge ink from each of the monochrome liquid discharge head 14A and the color liquid discharge head 14B, a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

Further, a plurality of sub tanks to supply and refill ink to the monochrome liquid discharge head 14A and the color liquid discharge head 14B is provided on the carriage 9. Respective color inks are supplied from the ink cartridges 15Y, 15M, 15C, and 15K (see FIG. 1) provided in the housing of the image forming apparatus 100, to each of the plurality of sub tanks, via respective ink supply tubes.

The drive device 19 includes a motor 28 that is a drive source, a drive pulley 29, a driven pulley 30, and a timing belt 35 that is wound around the drive pulley 29 and the driven pulley 30. As the motor 28 is driven to rotate the drive pulley 29, the timing belt 35 is moved endlessly, so that the carriage 9 coupled with the timing belt 35 moves in the main scanning direction E along the guide 10. By changing the rotational direction of the motor 28 between one direction and the opposite direction, the carriage 9 moves reciprocally in the main scanning direction E.

As the monochrome liquid discharge head 14A and the color liquid discharge head 14B discharge ink according to the image signal while the carriage 9 is moving in the main scanning direction E, an image for one line is formed on the sheet P that remains stationary. Then, after the sheet P has been conveyed by the predetermined distance in a direction indicated by arrow A illustrated in FIG. 2, the subsequent line of the image is formed on the sheet P. Thereafter, as in the above-described operation, conveyance and stop of the sheet P and the reciprocating motion of the carriage 9 are repeated, so that ink is discharged onto the sheet P to form the full image.

Next, a description is given of the configuration of the line-type liquid discharge head 14 as another example of the image forming device 3.

FIG. 3 is a plan view illustrating the image forming device 3 including the line-type liquid discharge head 14.

As illustrated in FIG. 3, the image forming device 3 includes a plurality of liquid discharge heads 14 aligned in the sheet conveyance direction A and the sheet width direction (main scanning direction E) of a base 36. Each of the monochrome liquid discharge head 14A and the color liquid discharge head 14B is provided with a nozzle row 54 with the arrangement of a plurality of nozzles.

In this case, as the sheet P is conveyed to the image forming device 3, when the sheet P passes through the opposing region facing the image forming device 3, the driving of ink discharge from each of the monochrome liquid discharge head 14A and the color liquid discharge head 14B is controlled by the drive signal based on the image information. Therefore, ink of each color is discharged from each of the monochrome liquid discharge head 14A and the color liquid discharge head 14B onto the sheet P. Accordingly, an image according to the image information is formed on the sheet P.

Hereinafter, the monochrome liquid discharge head 14A and the color liquid discharge head 14B are collectively referred to as the “liquid discharge head 14.”

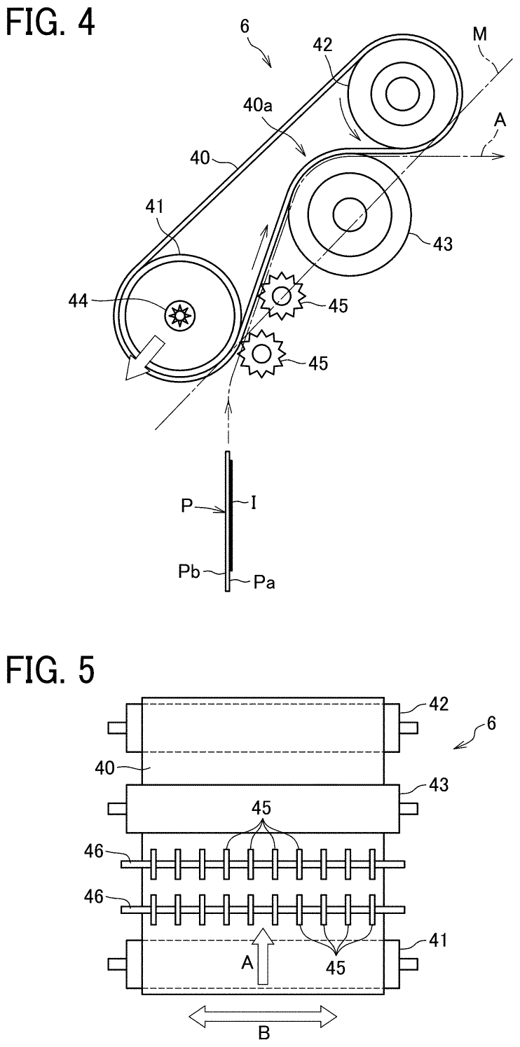

FIG. 4 is a diagram illustrating a schematic configuration of the drying device 6 provided in the image forming apparatus 100 of FIG. 1, according to the present embodiment.

As illustrated in FIG. 4, the drying device 6 includes a heat belt 40, a tension roller 41, a fixed roller 42, a pressure roller 43, a heater 44, and a plurality of spur wheels 45.

The heat belt 40 is a heating member to heat the sheet P while being in contact with the sheet P. The heat belt 40 includes an elastic endless belt that is wound around and rotatably supported by the tension roller 41 and the fixed roller 42.

The tension roller 41 and the fixed roller 42 are belt supports each rotatably supporting the heat belt 40. The tension roller 41 is movable inside the loop of the heat belt 40 and is pressed against the inner circumferential surface of the heat belt 40 by a biasing member such as a spring. On the other hand, the fixed roller 42 is fixed so as not to move.

The pressure roller 43 is a pressing member that presses the outer circumferential surface of the heat belt 40 between the tension roller 41 and the fixed roller 42. The tension roller 41 is disposed upstream from the pressure roller 43 in the sheet conveyance direction. The fixed roller 42 is disposed downstream from the pressure roller 43 in the sheet conveyance direction. The pressure roller 43 is pressed against the heat belt 40 by a pressing member such as a spring and a cam, toward the inside of the heat belt 40, in other words, toward the inside of the loop of the heat belt 40, from a common tangent line M that contacts the outer circumferential surface of the tension roller 41 and the outer circumferential surface of the fixed roller 42. By so doing, the heat belt 40 has a curved portion 40a that warps (curves) along the outer circumferential surface of the pressure roller 43.

The heater 44 is a heat source to heat the heat belt 40. In the present embodiment, the heater 44 is disposed inside the tension roller 41. Therefore, as the heater 44 generates heat, the heat is transmitted to the heat belt 40 via the tension roller 41, so that the heat belt 40 is heated. Accordingly, the tension roller 41 in the present embodiment functions as a heating member (heat rotator) to heat the heat belt 40 with the heat generated by the heater 44 disposed inside the tension roller 41. As a heat source, a radiation-type heater, e.g., a halogen heater and a carbon heater, to emit infrared ray, an electromagnetic induction-type heat source, and a warm air generation device may be employed. Further, the heater may be a contact-type heater or a non-contact type heater. In the present embodiment, a halogen heater is used as a heater 44.

Each spur wheel 45 functions as a projecting rotator having a plurality of projections projecting radially outward. The spur wheels 45 are disposed upstream from the pressure roller 43 in the sheet conveyance direction A to contact the outer circumferential surface of the heat belt 40.

Further, FIG. 5 is a plan view illustrating the drying device 6 indicating the arrangement of the spur wheels 45 provided in the drying device 6 of FIG. 4.

As illustrated in FIG. 5, the spur wheels 45 are mounted on a support shaft 46 that extends in a belt width direction B. Here, the “belt width direction” represents a direction intersecting the sheet conveyance direction A along the outer circumferential surface of the heat belt 40.

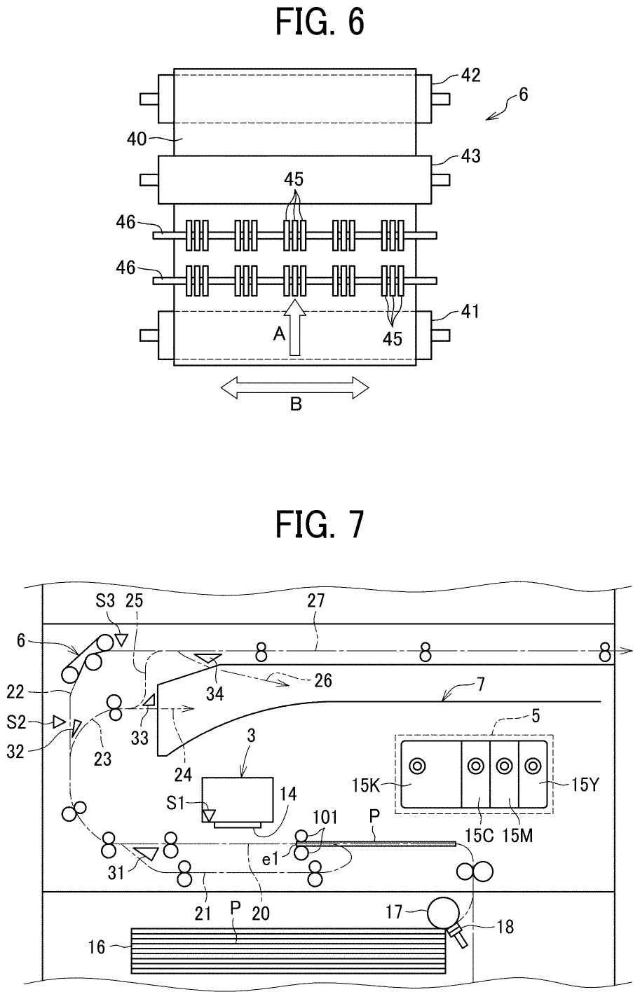

Further, FIG. 6 is a plan view illustrating the drying device 6 indicating another arrangement of the spur wheels 45.

As illustrated in FIG. 6, the drying device 6 may include the spur wheel groups, in each of which the plurality of spur wheels 45 are disposed closely to each other, may be disposed at equal intervals over the belt width direction B. Further, the spur wheels 45 may be disposed at different intervals over the belt width direction B. Alternatively, the spur wheel 45 on the upstream side and the spur wheel 45 on the downstream side in the sheet conveyance direction A may not be at the same position in the sheet conveyance direction A but may be shifted from each other in the belt width direction B.

Next, a description is given of the basic operations of the drying device 6.

As the print job starts, the fixed roller 42 rotates in a direction indicated by arrow in FIG. 4 (that is, a counterclockwise direction). By so doing, the heat belt 40 is rotated along with the rotation of the fixed roller 42, and the tension roller 41, the pressure roller 43, and the spur wheels 45 are rotated together with the rotation of the heat belt 40. Note that the tension roller 41 and the pressure roller 43 each may be function as a drive roller. Further, the heater 44 generates heat to heat the heat belt 40 via the tension roller 41. The heater 44 is controlled to maintain the temperature of the heat belt 40 within a range, for example, from 100° C. to 150° C.

In this state, as illustrated in FIG. 4, as the sheet P on which liquid ink I is applied is conveyed to the drying device 6, the sheet P enters between the spur wheel 45 and the heat belt 40. Thereafter, the sheet P is conveyed to pass between the pressure roller 43 and the heat belt 40, thereby ejecting the sheet P from the drying device 6. At this time, the sheet P is heated mainly by heat of the heat belt 40, which accelerates the drying of the ink I on the sheet P. Then, the sheet P is ejected from the drying device 6 and is conveyed to the sheet ejection portion 7 or the sheet alignment apparatus 200 as described above.

The amount of heat for drying the ink on the sheet depends on the amount of ink applied to the sheet. That is, as the amount of ink applied to a sheet increases, the amount of heat tends to increase. Therefore, in particular when the amount of ink applied to the sheet is large, it is preferable to increase the amount of heat to be supplied to the sheet. In order to increase the amount of heat to the sheet, there is a method of slowing down the speed of the sheet passing through the drying device. That is, as the speed of the sheet passing through the drying device slows down, the period of time to heat the sheet increases, thereby increasing the amount of heat to be supplied to the sheet.

However, as the speed of the sheet passing through the drying device is simply reduced, the period of time from image formation to sheet ejection increases, and therefore it is likely that the productivity (in other words, the number of output images per unit time) of the image forming apparatus deteriorates. Therefore, in order to resolve the negative effect on the productivity of the image forming apparatus, the image forming apparatus according to the present embodiment includes a controller 500 that functions as circuitry to control the speed of conveyance of the sheet.

Next, a description is given of a method of controlling the conveying speed of the sheet according to the present embodiment.

FIGS. 7 to 12 are diagrams illustrating a series of a method of controlling the conveying speed of the sheet.

As illustrated in FIG. 7, the leading end el of the sheet P supplied from the sheet feed tray 16 contacts a pair of timing rollers 101 that functions as a conveying member disposed upstream from the image forming device 3 in the sheet conveyance direction, so that the conveyance of the sheet is temporarily stopped.

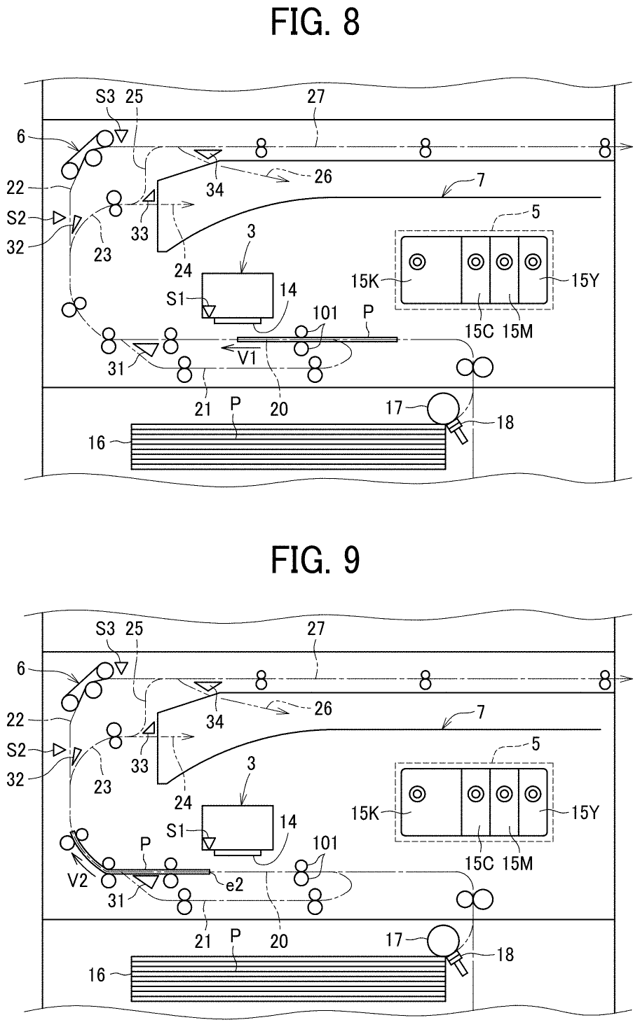

As the pair of timing rollers 101 starts to rotate under this state, the sheet P is conveyed toward the image forming device 3, as illustrated in FIG. 8, so that an image is formed on the sheet P. Here, the speed to convey the sheet P at which the sheet P passes through the image forming device 3 is defined as a first speed V1. However, the conveying operation of the sheet P when the sheet P passes through the image forming device 3 depend on whether the liquid discharge head 14 is a serial type or a line type. Therefore, the first speed V1 is defined according to each case as follows.

In a case in which the liquid discharge head 14 is a line-type liquid discharge head, the sheet P is conveyed continuously at a constant speed, and therefore the speed to convey the sheet P at which the sheet P passes through the image forming device 3 is defined as the first speed V1.

On the other hand, in a case in which the liquid discharge head 14 is a serial-type liquid discharge head, the sheet P is conveyed intermittently, and therefore the first speed V1 falls in any one of the following speeds (1) to (4):

(1) the speed to convey the sheet P from the pair of timing rollers 101 to the position at which the first line of an image is printed on the sheet P;

(2) the speed per unit time obtained by dividing the distance of conveyance of the sheet P from when the leading end of the sheet P (in the sheet conveyance direction) passes the pair of timing rollers 101 to when the trailing end of the sheet P passes a first sheet sensor S1 (see below), by the time of the conveyance of the sheet P;

(3) the speed per unit time obtained by dividing the distance of conveyance of the sheet P from when the leading end of the sheet P (in the sheet conveyance direction) passes the pair of timing rollers 101 to when the printing of the trailing end of the image on the sheet P is completed, by the time of the conveyance of the sheet P; and

(4) the speed to convey the sheet P from when the printing of one line of the image on the sheet P to when the sheet P moves by the distance for printing the subsequent one line of the image.

Thereafter, as illustrated in FIG. 9, when the trailing end e2 of the sheet P is detected by the first sheet sensor S1 that is disposed at or near the downstream end of the image forming device 3 in the sheet conveyance direction, the speed of the sheet P increases from the first speed V1 to a second speed V2 that is faster than the first speed V1, based on the detection signal of the first sheet sensor S1. In other words, the controller 500 causes the sheet P to be conveyed at the second speed V2 that is faster than the first speed V1 after the liquid discharge head 14 applies the liquid to the sheet P. Then, the sheet P is conveyed toward the drying device 6 at the second speed V2. Note that the timing to increase the speed of the sheet P from the first speed V1 to the second speed V2 may be the timing at which the printing of the final line of the image on the sheet P is completed.

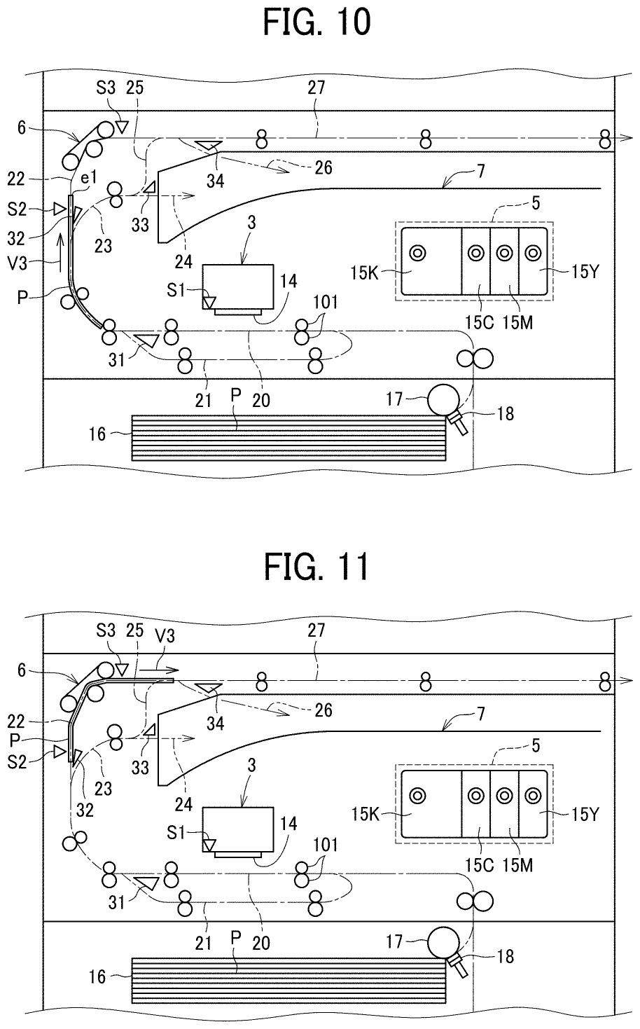

Thereafter, as illustrated in FIG. 10, when the leading end e1 of the sheet P is detected by a second sheet sensor S2 that is disposed upstream from the drying device 6 in the sheet conveyance direction, the speed of the sheet P decreases from the second speed V2 to a third speed V3 that is slower than the second speed V2, based on the detection signal of the second speed V2. In other words, the controller 500 decreases the speed of the sheet P from the second speed V2 to the third speed V3 that is slower than the second speed V2. Further, the controller 500 causes the sheet P to be conveyed at the third speed V3 when the sheet P passes the drying device 6.

Then, as illustrated in FIG. 11, the sheet P enters the drying device 6 at the third speed V3 to be heated by the drying device 6 while the sheet P is conveyed at the third speed V3.

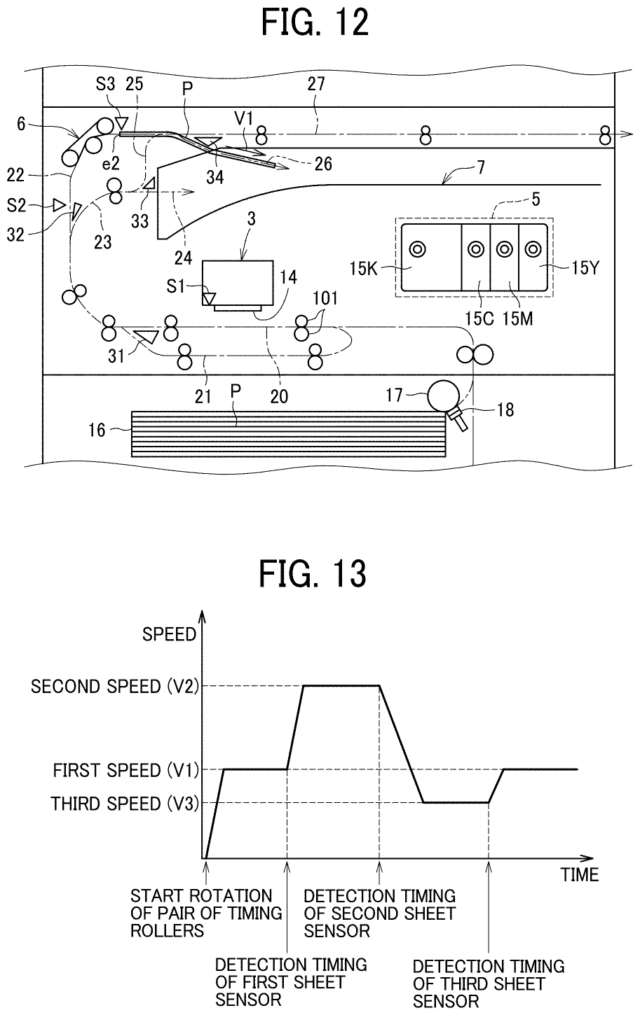

Thereafter, as illustrated in FIG. 12, when the trailing end e2 of the sheet P is detected by a third sheet sensor S3 that is disposed downstream from the drying device 6 in the sheet conveyance direction, the speed of the sheet P increases from the third sheet sensor S3 to the first speed V1, so that the sheet P is selectively conveyed to either the sheet ejection portion 7 or the sheet alignment apparatus 200.

As described above, in the image forming apparatus according to the present embodiment, after the ink is applied to the sheet P by the image forming device 3, the speed of the sheet P is increased from the first speed V1 to the second speed V2 to be conveyed to the drying device 6. When compared with a configuration in which the speed of the sheet P is not increased, this configuration in which the speed of the sheet P is increased from the first speed V1 to the second speed V2 reduces the time from when ink is applied to the sheet P to when the sheet P is selectively conveyed to either the sheet ejection portion 7 or the sheet alignment apparatus 200. Accordingly, the energy-saving performance of the image forming apparatus is enhanced.

Further, in the image forming apparatus according to the present embodiment, the speed of the sheet P is changed from the second speed V2 to the third speed V3 that is slower than the second speed V2 before the sheet P enters the drying device 6. By so doing, the time at which the drying device 6 heats the sheet P is increased reliably. Such a configuration allows the ink on the sheet P to be effectively dried.

Further, in the image forming apparatus according to the present embodiment, the timing to increase or decrease the speed of the sheet P is determined based on the detection signals of three sheet sensors which are the first sheet sensor S1, the second sheet sensor S2, and the third sheet sensor S3, each functioning as a sheet detector (conveyance target object detector) to detect the sheet. According to this configuration, the speed of the sheet P is increased or decreased at the predetermined timing reliably. In other words, the controller 500 changes the speed of the sheet P from the first speed V1 to the second speed V2 based on the detection timing of each of the first sheet sensor S1, the second sheet sensor S2, and the third sheet sensor S3.

In order to enhance the productivity, it is preferable that the first sheet sensor S1 is disposed at a position near the downstream end of the liquid discharge head 14 in the sheet conveyance direction. By disposing the first sheet sensor S1 at or near the downstream end of the liquid discharge head 14 in the sheet conveyance direction, the speed of the sheet P is increased to the second speed V2 at a relatively early timing, thereby enhancing the productivity. For example, when the liquid discharge head 14 is a serial-type liquid discharge head, the first sheet sensor S1 is preferably mounted on the lateral side face of the carriage 9 (that is, the left side face of the carriage 9 or the right side face of the carriage 9 in FIG. 2). Further, when the liquid discharge head 14 is a line-type liquid discharge head, the first sheet sensor S1 is preferably mounted on the downstream end of the base 36 in the sheet conveyance direction (that is, the upper end face of the base 36 in FIG. 3). Note that the first sheet sensor S1 may be mounted on the housing of the image forming apparatus instead of the image forming device 3.

In order to enhance the productivity, it is preferable that the second sheet sensor S2 is disposed at a position as close to the drying device 6 as possible. That is, by decelerating the speed of the sheet P at a position as close to the drying device 6 as possible, the sheet P is conveyed at a relatively fast speed (e.g., the second speed V2) for a relatively long time, thereby enhancing the productivity of the image forming apparatus. However, since the conveying speed (the rotational speed of the pair of sheet conveying rollers) may not be changed instantaneously, it is preferable that the second sheet sensor S2 is disposed upstream from a position immediately before the entrance of the drying device 6. That is, since the heat belt 40 of the drying device 6 rotates at the same speed as the third speed V3, it is preferable that the speed of the sheet P is completely changed from the second speed V2 to the third speed V3 before the leading end of the sheet P contacts the heat belt 40. Accordingly, an image on the sheet P is prevented from being rubbed by the heat belt 40 that may be caused by inconsistency between the speed of the sheet P and the rotational speed of the heat belt 40.

Similarly, in order to enhance the productivity, it is also preferable that the third sheet sensor S3 is disposed at a position as close to the drying device 6 as possible. By so doing, the speed of the sheet P is changed from the third speed V3 to the faster speed (e.g., the first speed V1) at a relatively early timing.

FIGS. 13, 14, and 15 are graphs each illustrating the changes of the above-described conveying speed in chronological order.

Note that the case here is assumed that the image forming device 3 is the line-type liquid discharge head 14 as illustrated in FIG. 3.

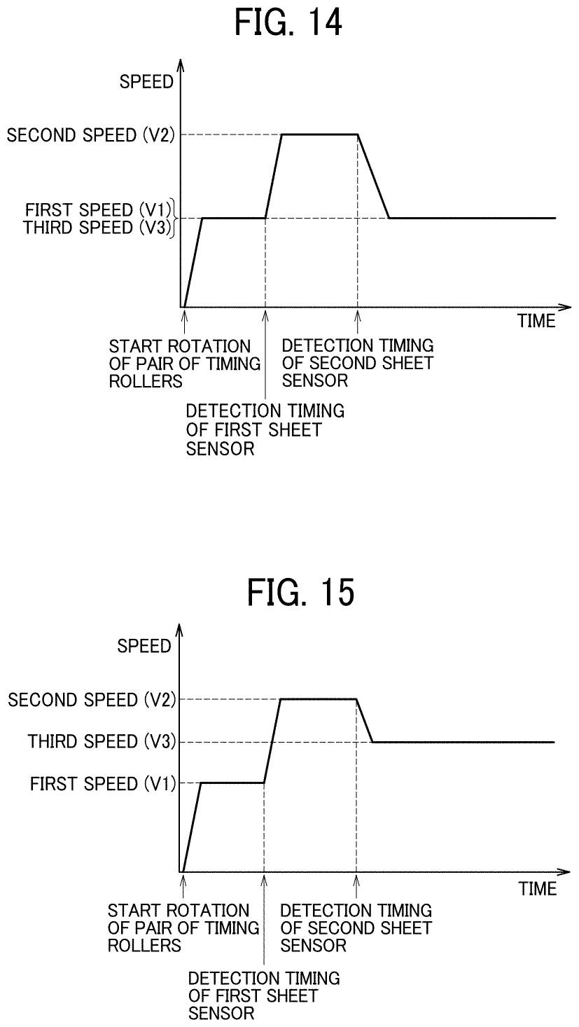

As illustrated in FIG. 13, in the above-described embodiment, the third speed V3 is set to be slower than the first speed V1. In other words, the controller 500 causes the sheet P to be conveyed at the third speed V3 that is slower than the first speed V1. Accordingly, the time in which the sheet P passes through the drying device 6 is increased, and therefore the ink on the sheet P is effectively dried. However, the third speed V3 is not limited to this example and may be the same speed as the first speed V1 as in the example illustrated in FIG. 14 or the speed between the first speed V1 and the second speed V2 as in the example illustrated in FIG. 15. The setting of the third speed V3 may be appropriately determined in consideration of the performance (drying capacity) of the drying device 6 and the productivity of the image forming apparatus 100.

Further, the third speed V3 may be changed according to the amount of ink applied to the sheet P. In other words, the controller 500 changes the speed of the sheet P when the sheet P passes the drying device 6 according to the amount of ink applied to the sheet P. For example, in a case in which the amount of ink applied to the sheet is relatively large, the third speed V3 is set to be a speed slower than the first speed V1, as illustrated in FIG. 13, so that the time to heat the sheet increases. By contrast, in a case in which the amount of ink applied to the sheet is relatively small, the third speed V3 is set to be a speed relatively fast between the first speed V1 and the second speed V2, as illustrated in FIG. 15, so that the productivity of the image forming apparatus may be enhanced.

Detection of the amount of ink applied to the sheet may be replaced with, for example, detection of the image resolution or the image area rate. That is, since the amount of ink applied to the sheet changes according to the image resolution or the image area rate of the image, when the image resolution or the image area rate is detected, the amount of ink applied to the sheet is also detected indirectly. Further, the image resolution and the image area rate may be obtained from image information read by the image reading device 2 and image information input via a terminal device different from the image forming apparatus. Then, in a case in which the image resolution or the image area rate obtained from image information is equal to or greater than the predetermined image resolution or the predetermined image area rate, it is determined that the amount of ink applied to the sheet is relatively large (that is, greater than the predetermined amount of ink applied to the sheet), and the third speed V3 may be changed to a speed slower than the first speed V1. By contrast, in a case in which the image resolution or the image area rate is smaller than the predetermined image resolution or the predetermined image area rate, it is determined that the amount of ink applied to the sheet is relatively small (smaller than the predetermined amount of ink applied to the sheet), and the third speed V3 may be changed to a speed relatively fast between the first speed V1 and the second speed V2. Further, such a change in speed is not limited to a change based on the above-described determination but may be a change based on mode information selected from image formation modes having various image resolutions or based on the total amount of ink discharged from the liquid discharge head 14.

Next, a description is given of the conveying operation when sheets are continuously conveyed.

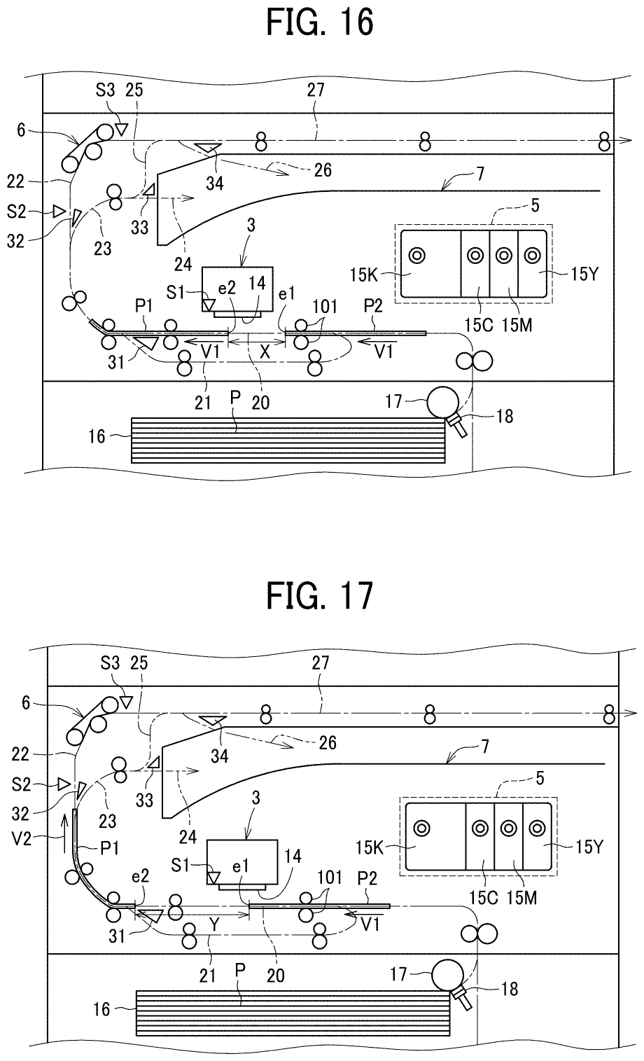

FIGS. 16 to 20 are diagrams illustrating the conveying operation when sheets are continuously conveyed. That is, FIGS. 16 to 20 illustrate the conveying operation when an image is formed on a preceding sheet P1 and a subsequent sheet P2 is conveyed toward the image forming device 3. At this time, since the trailing end e2 of the preceding sheet P2 has not yet reached the position of the first sheet sensor S1, the speed has not been changed from the first speed V1 to the second speed V2, and therefore the sheet P is conveyed at the first speed V1. Similarly, the subsequent sheet P2 is conveyed at the first speed V1. In this state, an interval X in the sheet conveyance direction is provided between the trailing end e2 of the preceding sheet P1 and the leading end e1 of the subsequent sheet P2.

Thereafter, as illustrated in FIG. 17, when the trailing end e2 of the preceding sheet P1 passed the first sheet sensor S1, the speed of the preceding sheet P1 is increased from the first speed V1 to the second speed V2. On the other hand, since the subsequent sheet P2 is conveyed at the first speed V1, the distance between the trailing end e2 of the preceding sheet P1 and the leading end e1 of the subsequent sheet P2 increases from the interval X to an interval Y.

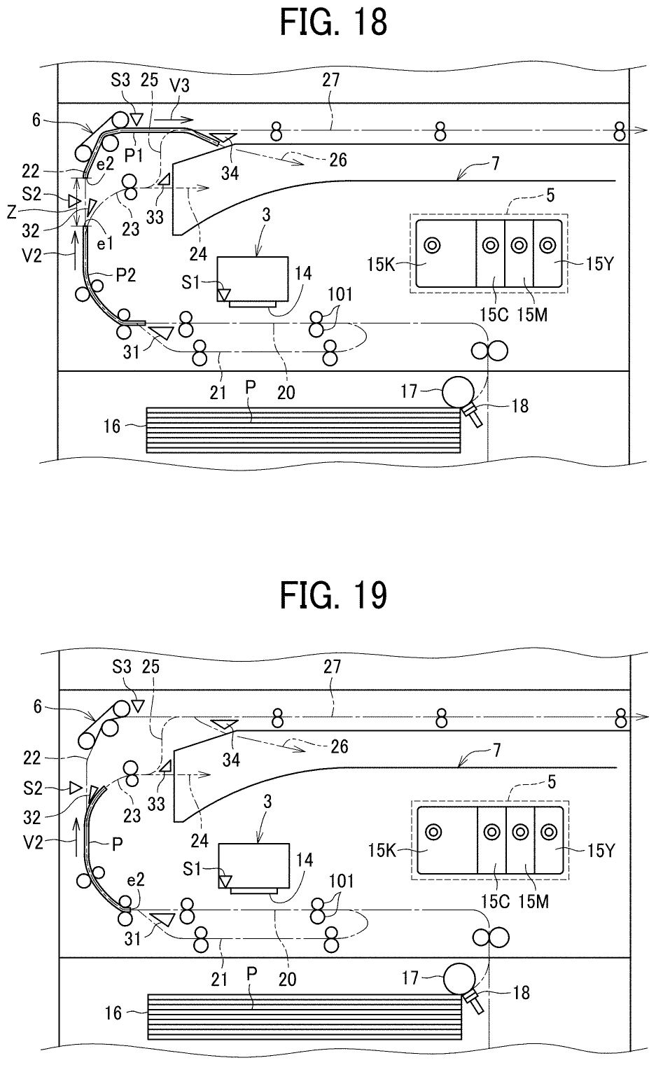

Thereafter, as illustrated in FIG. 18, the speed of the preceding sheet P1 is decreased from the second speed V2 to the third speed V3 before the preceding sheet P1 enters the drying device 6 and passes through the drying device 6 at the third speed V3. On the other hand, since the speed of the subsequent sheet P2 is increased from the first speed V1 to the second speed V2, the distance between the trailing end e2 of the preceding sheet P1 and the leading end e1 of the subsequent sheet P2 decreases from the interval Y to an interval Z.

However, since the distance (interval) between the preceding sheet P1 and the subsequent sheet P2 is previously increased to the interval Y, even when this distance (interval) decreases, the subsequent sheet P2 does not catch up with the preceding sheet P1 or does not overlap the preceding sheet P1.

As described above, after an image has been formed on the preceding sheet P1, the speed of the preceding sheet P1 is increased to the second speed V2 temporarily. By so doing, even when the speed of the preceding sheet P1 is increased to the second speed V2 and then decreased to the third speed V3, the preceding sheet P1 is not caught up with the subsequent sheet P2, and therefore the time to heat the preceding sheet P1 is increased. Such a configuration allows the ink on the sheet P to be effectively dried, and therefore enhances the productivity of the image forming apparatus.

Further, in a case in which no sheet sensor is used, in consideration of the decrease in the conveying force due to over-time wearing of the pair of sheet conveying rollers, the timing to increase the speed of the sheet P is set to be relatively late so that the speed of the sheet P is increased after the trailing end of the sheet has surely passed under the liquid discharge head 14. However, in a case in which a sheet sensor is used as in the present embodiment, the above-described operation is omitted or eliminated. That is, since the timing to increase after the trailing end of the sheet has passed the liquid discharge head 14 is set earlier by using the first sheet sensor S1, the interval between the preceding sheet P1 and the subsequent sheet P2 (interval Y illustrated in FIG. 17) is increased. Accordingly, it is less likely to cause the preceding sheet P1 and the subsequent sheet P2 to overlay each other and the speed at which the sheet passes through the drying device 6 (the third speed V3) is set to be slower. Therefore, ink on the sheet is dried more effectively.

Further, the interval between the preceding sheet P1 and the subsequent sheet P2 may depend on the sheet size (in the sheet conveyance direction). For example, the interval between the sheets when a relatively large sheet is conveyed may be greater than the interval between the sheets when a relatively small sheet is conveyed. In a case in which the interval between the sheets is relatively large, even when the speed of the subsequent sheet P2 is increased, it is less likely that the subsequent sheet P2 catches up with the preceding sheet P1. Therefore, the second speed V2 of the subsequent sheet P2 when the interval between the sheets is relatively large may be set faster than the second speed V2 of the subsequent sheet P2 when the interval between the sheets is relatively small.

Further, in a case in which the interval between the sheets is relatively large, even when the speed of the preceding sheet P1 is decreased, it is less likely that the subsequent sheet P2 catches up with the preceding sheet P1. Therefore, the third speed V3 of the preceding sheet P1 when the interval between the sheets is relatively large may be set slower than the third speed V3 of the preceding sheet P1 when the interval between the sheets is relatively small. In other words, the controller 500 changes at least one of the second speed V2 and the third speed V3 according to the interval between the preceding sheet P1 and the subsequent sheet P2 in the sheet conveyance direction.

Further, in a case in which the interval between the sheets is relatively large, the timing to increase the speed of the subsequent sheet P2 may be set at a relatively early stage. Therefore, the timing to increase the speed of the subsequent sheet P2 from the first speed V1 to the second speed V2 may be set earlier when the interval between the sheets is relatively large, than the timing when the interval between the sheets is relatively small.

Further, in a case in which the interval between the sheets is relatively large, the timing to decrease the speed of the subsequent sheet P2 may be set later. Therefore, the timing to decrease the speed of the subsequent sheet P2 from the second speed V2 to the third speed V3 may be set later when the interval between the sheets is relatively large, than the timing when the interval between the sheets is relatively small. In other words, the controller 500 changes at least one of a timing to change the conveying speed from the first speed to the second speed and a timing to change the conveying speed of the subsequent sheet P2 from the second speed V2 to the third speed V3, according to the interval between the preceding sheet P1 and the subsequent sheet P2 in the sheet conveyance direction of the preceding sheet P1 and the subsequent sheet P2.

Further, the above-described control of the conveying speed is applicable to a case in which the sheet is conveyed to the sheet reverse passage when performing a duplex printing.

To be more specific, as illustrated in FIG. 19, as the controller 500 increases the speed of the sheet P having an image on one face (i.e., the first face) from the first speed V1 to the second speed V2 to convey the sheet downstream in the sheet conveyance direction and the trailing end e2 of the sheet P passes the first passage changer 31, conveyance of the sheet P is temporarily stopped. Further, at this time, the first passage changer 31 changes the sheet conveyance passage of the sheet P to the sheet reverse passage 21.

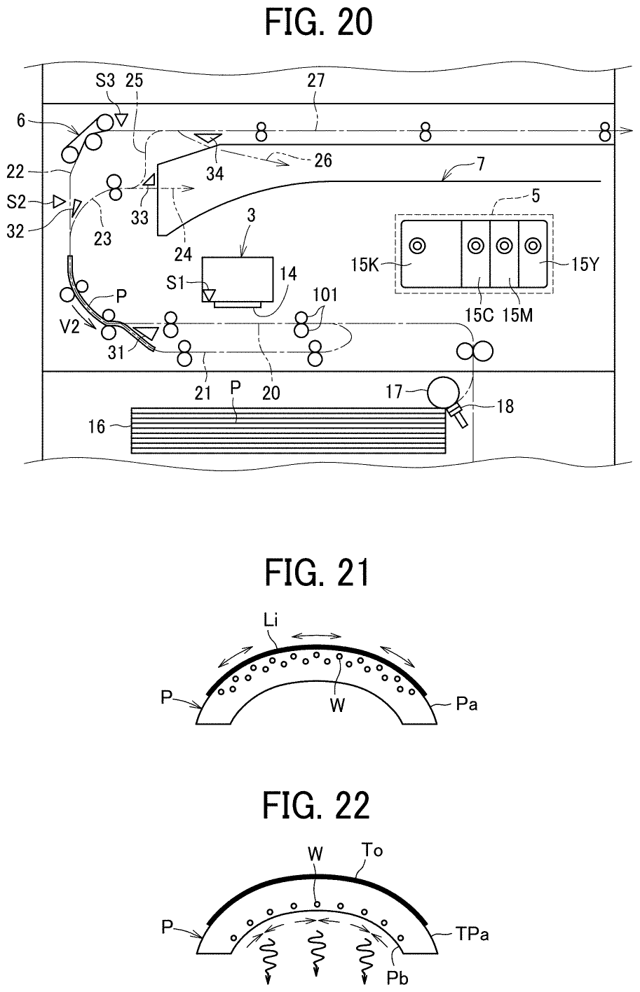

Then, as illustrated in FIG. 20, the sheet P is conveyed in the reverse direction to guide the sheet P to the sheet reverse passage 21. The speed of the sheet P at this time is set to be the second speed V2 that is faster than the first speed V1. Thereafter, after the sheet P contacts the pair of timing rollers 101 to stop the conveyance of the sheet P, the pair of timing rollers 101 conveys the sheet P to the image forming device 3 at the first speed V1. By so doing, the sheet P is conveyed to the image forming device 3 while the front face of the sheet P is reversed to the back face, and another image is formed on the opposite face (i.e., the back face) of the sheet P. Thereafter, the controller 500 controls the speed of the sheet P by executing the same conveyance control as the above-described control of the conveyance control (to increase to the second speed V2 and then decrease to the third speed V3), so that the controller 500 causes the sheet P to be conveyed toward the drying device 6.

As described above, when the sheet P is conveyed to the sheet reverse passage 21 when performing the duplex printing, the speed of the sheet P is temporarily increased to the second speed V2, thereby enhancing the productivity of the image forming apparatus. Further, as in this example, the length of the sheet conveyance passage eventually becomes shorter when the sheet P is conveyed to the drying device 6 after images have already been formed on both the front face and the back face, than when the sheet P is conveyed to the drying device 6 each time an image is formed on one face (that is, either the front face or the back face) of the sheet P. Therefore, the productivity of the image forming apparatus is enhanced. However, the total amount of heat to be supplied from the drying device 6 to the sheet P is decreased when the sheet P is conveyed with images on both faces. Therefore, it is preferable to convey the sheet P to the drying device 6 after the images are formed on both faces of the sheet P when the amount of ink to be applied to the sheet P is relatively small.

As described above, the configuration and method capable of achieving the good drying performance and the good productivity according to the present disclosure have been explained. However, the configuration of the drying device according to the above-described embodiment (e.g., the configuration illustrated in FIG. 4) is capable of achieving the following effects.

Next, a description is given of the effects of the operation of the drying device according to an embodiment of the present disclosure configuration of the drying device 6 according to the above-described embodiment.

In the drying device 6 according to the embodiment illustrated in FIG. 4, as the sheet P on which the ink I is applied is conveyed to the drying device 6, the opposite face Pb of the sheet P that is opposite the liquid applied face Pa (on which the ink I is applied) of the sheet P contacts the heat belt 40. By so doing, the sheet P is heated mainly from the opposite face Pb of the sheet P. As described above, in the drying device 6 illustrated in FIG. 4, the sheet P is mainly heated from the opposite face Pb that is opposite the liquid applied face Pa, thereby restraining generation of back curl on the sheet P.

Hereinafter, a description is given of the principle of back curl generation and the effect of restraining the back curl.

FIG. 21 is a diagram for explaining the principle of generation of a back curl on a sheet.

Generally, in a case of a plain paper, when liquid Li is applied to one side, that is, the liquid applied face Pa of the sheet P as illustrated in FIG. 21, water W in the liquid Li stretches fabric on the liquid applied face Pa of the sheet P in a specified direction, which generates a curl. More specifically, the water W permeates between the cellulose fibers of the sheet P and breaks the hydrogen bond of the cellulose fibers. By so doing, the intervals of the cellulose fibers increase, and therefore the sheet P extends in the specified direction. As a result, the sheet P warps upward to cause the image forming surface (liquid applied face Pa) to have a curl in a convex shape. The curl is referred to as a back curl.

Further, FIG. 22 is a diagram for explaining the principle of generation of another back curl on a sheet.

In an electrophotographic image forming apparatus that forms an image with toner, as the image forming surface of the sheet is heated to fix the toner to the sheet, a curl similar to the back curl may be generated. To be more specific, as illustrated in FIG. 22, when the image forming surface (toner applied face TPa) of the sheet P, to which toner To is applied, is heated with the higher temperature, the water content of the water W originally contained in the sheet P increases to be higher on the opposite face Pb than on the toner applied face TPa. As a result, the shrinkage of the sheet P caused by the subsequent drying after heating is more remarkable on the opposite face Pb than on the toner applied face TPa. This shrinkage causes the image forming surface (toner applied face TPa) of the sheet P to warp upward in a convex shape to generate a back curl.

On the contrary to the example of a back curl illustrated in FIG. 22, in the drying device 6 illustrated in FIG. 4, the sheet P is heated from the opposite face Pb that is opposite the image forming surface (liquid applied face Pa) of the sheet P. That is, on the contrary to example of the back curl illustrated in FIG. 22, the opposite face Pb of the sheet P is heated at the temperature higher than the temperature of the liquid applied face Pa of the sheet P. Therefore, a force is exerted in the opposite direction to a force applied to the sheet P to generate the back curl. Accordingly, the drying device 6 illustrated in FIG. 4 restrains generation of back curl, thereby reducing or eliminating inconveniences such as a conveyance failure by the sheet having a back curl and a decrease in the number of sheets stackable in the sheet ejection tray.

Further, in the drying device 6 illustrated in FIG. 4, when the sheet P passes (the curved portion 40a) between the pressure roller 43 and the heat belt 40, the sheet P is conveyed along the curved portion 40a of the heat belt 40 while the liquid applied face Pa of the sheet P is warped in the concave shape. That is, by passing through the curved portion 40a of the heat belt 40, the sheet P is warped in the direction opposite the back curl direction (the warping direction in which the liquid applied face Pa has the convex shape, in other words, the outwardly warped shape) over the sheet conveyance direction A.

As described above, in the drying device 6 illustrated in FIG. 4, the sheet P is heated from the opposite face Pb that is opposite the liquid applied face Pa and is further warped in the direction opposite the back curl direction, thereby effectively restraining generation of back curl on the sheet P.

Further, such an effect of restraining back curl is similarly obtained when drying the image on the back face of the sheet P in the duplex printing. That is, in a case in which the image formed on the back face of the sheet P is dried, the sheet P is heated from the opposite face Pb (front face) opposite the liquid applied face Pa (back face), so that the force is exerted in the opposite direction to the force that generates a back curl to the sheet P. Note that, since ink is applied to both the front and back faces of the sheet P in the duplex printing, both faces may be the “liquid applied face.” However, the “liquid applied face” referred to in the description of the present disclosure represents the face on which liquid is applied (front face) when the sheet P has the liquid on a single face or the face on which liquid is applied for the second time (back face) when the sheet P has the liquid on both the front and back faces.

Further, since the plurality of spur wheels 45 is disposed upstream from the pressure roller 43 in the sheet conveyance direction A in the drying device 6 illustrated in FIG. 4, the sheet P is guided by the plurality of spur wheels 45 before the sheet P reaches the pressure roller 43. At this time, even if the ink applied on the sheet P is in the liquid state, since the contact area of the spur wheel 45 or the plurality of spur wheels 45 to the liquid applied face Pa is smaller than the contact area of a generally used sheet conveying roller, ink smudge on the sheet P caused by the contact of the spur wheel 45 or the plurality of spur wheels 45 to the sheet P is prevented. Further, application of ink to the spur wheel 45 is reduced, so as to restrain the sheet from smear caused by ink being applied from the spur wheel 45 to another sheet.

Further, since the sheet P is guided by the spur wheel 45 to contact the heat belt 40, the sheet P contacts the heat belt 40 before reaching the pressure roller 43, which accelerates the drying of ink on the sheet P. Accordingly, when the sheet P contacts the pressure roller 43, distortion in the image is restrained. Further, after the sheet P has reached the pressure roller 43, the pressure roller 43 presses the sheet P against the heat belt 40 so that the sheet P closely contacts the heat belt 40. Accordingly, the heat is effectively supplied to the sheet P due to the close contact of the sheet P to the heat belt 40, and therefore the drying of the ink on the sheet P is further accelerated.

In addition, in the drying device 6 illustrated in FIG. 4, the heater 44 is disposed upstream from the pressure roller 43 (or the curved portion 40a) in the sheet conveyance direction A. Therefore, the sheet P is effectively heated on the upstream side from the pressure roller 43 in the sheet conveyance direction A. Accordingly, the drying of the ink on the sheet P is accelerated before the sheet P reaches the pressure roller 43 and ink application to the pressure roller 43 is restrained effectively.

In order to further restrain ink application to the pressure roller 43, a roller having the uneven outer circumferential surface, in other words, having convex and concave portions on the outer circumferential surface may be employed to reduce the contact area of the pressure roller 43 to the sheet P.

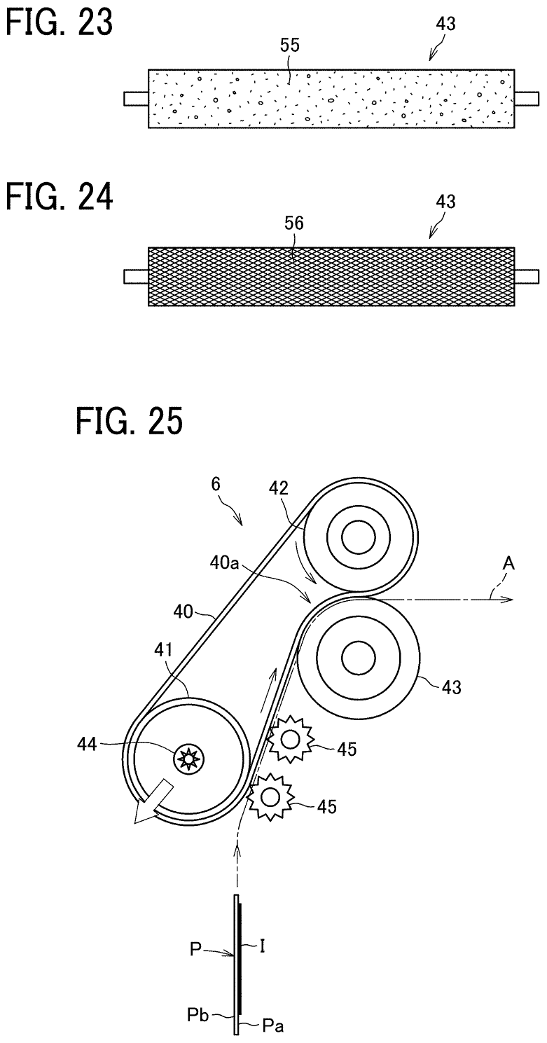

FIG. 23 is a diagram illustrating an example of a pressure roller employing an abrasive roller.

FIG. 24 is a diagram illustrating an example of a pressure roller employing a knurl roller.

For example, the pressure roller 43 may employ an abrasive roller having the outer circumferential surface on which abrasive grains 55 such as a plurality of ceramic or glass are attached, as illustrated in FIG. 23. Alternatively, the pressure roller 43 may employ a knurl roller having the outer circumferential surface on which meshed convex-concave portions (knurling) 56 are provided, as illustrated in FIG. 24.

In the drying device 6 illustrated in FIG. 4, the plurality of spur wheels 45 are disposed upstream from the pressure roller 43 in the sheet conveyance direction A. Therefore, as the sheet P is conveyed to the drying device 6 while the sheet P is deformed due to cockling, for example, the plurality of spur wheels 45 conveys the sheet P while holding the sheet P in a flat shape on the heat belt 40. Accordingly, the sheet P enters in a flat shape between the pressure roller 43 and the heat belt 40, thereby restraining occurrence of wrinkles on the sheet P.

Note that the plurality of spur wheels 45 may not contact the outer circumferential surface of the heat belt 40. As long as the sheet P is conveyed while being held in a flat shape without waving on the heat belt 40, the spur wheel 45 or the plurality of spur wheels 45 may be disposed close to the outer circumferential surface of the heat belt 40 (indirectly contacting the outer circumferential surface of the heat belt 40 via a gap). In other words, as long as a good conveyability of sheets is obtained, the spur wheel 45 or the plurality of spur wheels 45 may be in contact with the heat belt 40 or without contacting the heat belt 40.

Further, in the drying device 6 illustrated in FIG. 4, the pressure roller 43 is not pressed against each of the tension roller 41 and the fixed roller 42 via the heat belt 40, in other words, is spaced away from each of the tension roller 41 and the fixed roller 42. That is, the pressure roller 43 contacts the heat belt 40 at the position away from the tension roller 41 and the fixed roller 42 relative to the heat belt 40 in the sheet conveyance direction A. Therefore, occurrence of wrinkles on the sheet P caused by pressing the sheet P strongly is restrained. That is, since no nip region is formed by application of pressure by the pressure roller 43 and another roller on the sheet conveyance passage of the heat belt 40, the sheet P is not strongly pressed (in the nip region) between the rollers, thereby restraining occurrence of wrinkles on the sheet P. Further, the load to be applied to the heat belt 40 when the heat belt 40 is pressed (in the nip region) between the rollers is reduced, thereby enhancing the durability of the heat belt 40 and extending the service life of the heat belt 40. Further, the rotational resistance of the heat belt 40 is also reduced, thereby increasing the efficiency of rotation of the heat belt 40 and saving the driving energy.

FIG. 25 is a diagram illustrating an example that the pressure roller 43 contacts the fixed roller 42 via the heat belt 40.

FIG. 26 is a diagram illustrating an example that the pressure roller 43 contacts the tension roller 41 and the fixed roller 42 via the heat belt 40.

As described above, in order to restrain occurrence of wrinkles on the sheet, it is preferable that the pressure roller 43 is not pressed in contact with another roller via the heat belt 40. However, other than this case, in order to restrain deformation of the sheet such as back curl more effectively, the pressure roller 43 may be pressed in contact with the fixed roller 42 via the heat belt 40, as illustrated in FIG. 25. Further, as illustrated in FIG. 26, the pressure roller 43 may be pressed in contact with each of the tension roller 41 and the fixed roller 42 via the heat belt 40.

FIG. 27 is a diagram illustrating an example of an air blowing fan 61 instead of the spur wheels 45.

As illustrated in FIG. 27, instead of the above-described spur wheel 45, the air blowing fan 61 that functions as an air blower may be employed as another device to restrain the image distortion and cause the sheet P to contact the heat belt 40. In this case, the air blowing fan 61 blows air to cause the sheet P to contact the heat belt 40, so that the sheet P is conveyed while being held in a flat shape without being pressed strongly. Further, the air blowing fan 61 may be a warm air blowing fan that blows warm air to restrain the heat belt 40 from being cooled.

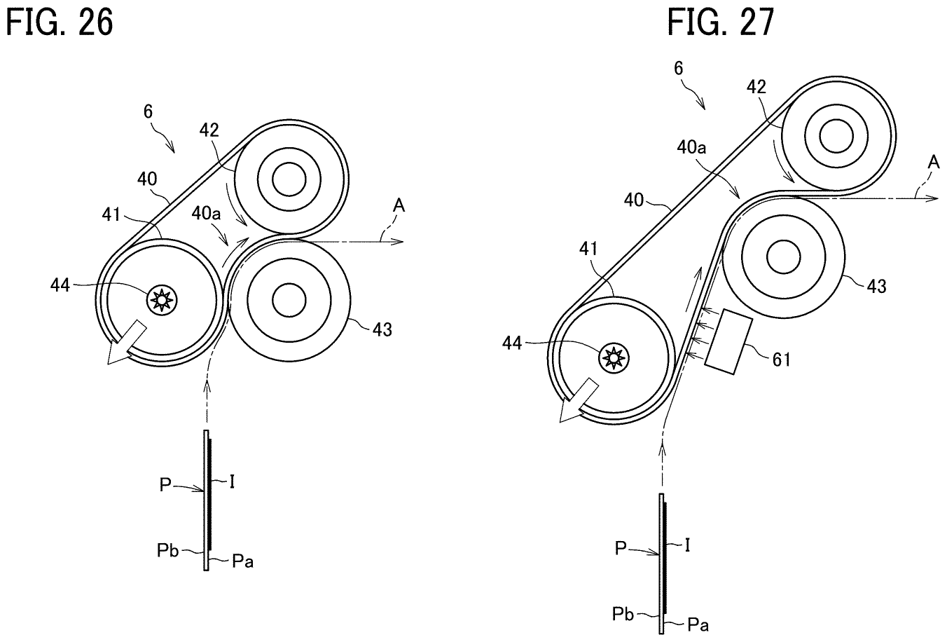

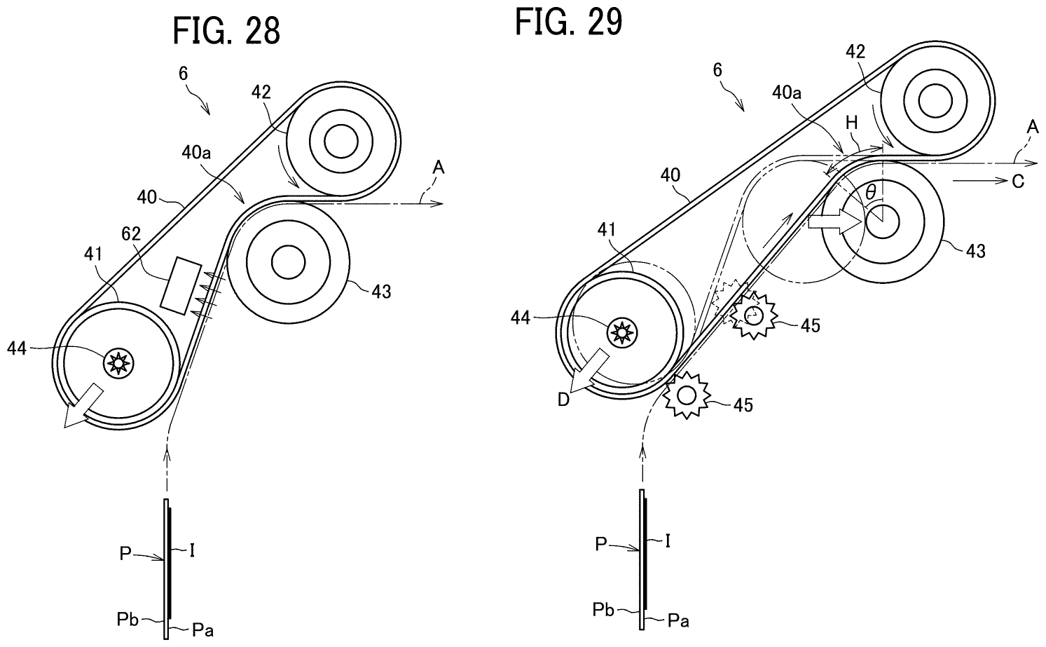

Further, FIG. 28 is a diagram illustrating an example of an air suction fan 62 instead of the spur wheels 45.

To be more specific, as yet another example, as illustrated in FIG. 28, the air suction fan 62 that functions as an air suction member may be disposed inside the loop of the heat belt 40. In this case, the heat belt 40 has a plurality of air holes and the air suction fan 62 sucks air from the plurality of air holes of the heat belt 40. By so doing, the sheet P is attracted to the heat belt 40. Accordingly, the sheet P is conveyed while being held in a flat shape on the heat belt 40 without being pressed strongly.

Further, in addition to the above-described methods using the air blowing fan 61 and the air suction fan 62, a method by which the heat belt 40 is charged to cause the sheet P to be electrostatically attracted to the charged heat belt 40 may be employed.

FIG. 29 is a diagram illustrating an example that the winding angle of the heat belt 40 around the pressure roller 43 is changeable.

As illustrated in FIG. 29, the pressure roller 43 may be moved to make the winding angle θ of the heat belt 40 to the pressure roller 43 changeable. Accordingly, the length H of the contact area (curved portion 40a) in the sheet conveyance direction A, in which the pressure roller 43 and the heat belt 40 contact, is changeable.

For example, when an image having a low image area rate with texts, the amount of ink application to the sheet P is relatively small, and therefore it is not likely to generate back curl easily. Therefore, when an image having a low image area rate is formed on the sheet P, as illustrated in FIG. 29, the pressure roller 43 is moved to the right side in FIG. 29 to reduce the winding angle θ of the heat belt 40 to the pressure roller 43, so as to reduce the length H of the contact area in the sheet conveyance direction A. In this case, a decurling action performed when the sheet P passes the curved portion 40a of the heat belt 40 is decreased to apply a decurling force corresponding to the amount of curl of a possible back curl. Note that, in this case, a reduction in the length H of the contact area of the pressure roller 43 and the heat belt 40 in the sheet conveyance direction A decreases the time to heat the sheet P while the sheet P is pressed against the heat belt 40 by the pressure roller 43. That is, even though the amount of heat to be applied from the heat belt 40 to the sheet P is reduced, when the image area rate is relatively small and the amount of ink application to the sheet P is also relatively small, the time to heat the sheet P for drying may be relatively short. Therefore, the winding angle θ of the heat belt 40 to the pressure roller 43 may be reduced. Further, the amount of heat to be applied to the sheet P from the heat belt 40 decreases, the energy-saving effect is achieved.

By contrast, when an image having a high image area rate and a high amount of ink application is formed, the pressure roller 43 is moved to the left side in FIG. 29 to increase the winding angle θ of the heat belt 40 to the pressure roller 43, so as to increase the length H of the contact area in the sheet conveyance direction A. Accordingly, the decurling action performed when the sheet P passes the curved portion 40a of the heat belt 40 is increased to effectively restrain deformation of the sheet such as back curl.

Further, when a relatively thick sheet P such as a thick paper is conveyed, if the winding angle θ is large, it is difficult to warp and convey the sheet P. Therefore, it is preferable to make the winding angle θ relatively small. By making the winding angle θ relatively small, even when the thick sheet P is conveyed, the sheet P is smoothly conveyed, and therefore occurrence of a conveyance failure may be prevented. As described above, by accordingly changing the winding angle θ depending on the thickness of the sheet and the amount of ink application to the above-described sheet, deformation of the sheet is effectively restrained and the conveyance performance and the energy-saving performance are enhanced.

Further, in addition to the above-described change of the winding angle θ of the heat belt 40, when the amount of ink application to the sheet P is relatively small, by reducing the amount of heat generation of the heater 44, the energy-saving performance is more enhanced when compared with a case in which the amount of ink application to the sheet P is relatively large.

Further, it is preferable that the direction of movement of the pressure roller 43 when changing the winding angle θ of the heat belt 40 is parallel to the direction of the heat belt 40 extending downstream from the pressure roller 43 in the sheet conveyance direction A (i.e., the direction indicated by arrow C in FIG. 29). By so doing, even when the pressure roller 43 is moved, the sheet ejection direction of the sheet P from the drying device 6 may not be changed, thereby ejecting the sheet P reliably. Further, in the drying device 6 according to the present embodiment, as the sheet P passes the curved portion 40a of the heat belt 40, the sheet conveyance direction of the sheet P is changed. That is, by employing a belt member having the curved portion, the sheet P is changed to the desired sheet conveyance direction easily to convey the sheet P.

Further, as illustrated in FIG. 29, as the pressure roller 43 moves, the tension roller 41 moves together with the pressure roller 43, so that the tension applied to the heat belt 40 is adjusted to the predetermined value. At this time, by setting the direction of movement of the tension roller 41 to the direction obliquely downward to the left (direction indicated by arrow D in FIG. 29) and the direction opposite the direction obliquely downward to the left, the spur wheel 45 at the extreme upstream position in the sheet conveyance direction A and the heat belt 40 are continuously in contact with each other and maintain the contact state without moving the spur wheel 45 at the extreme upstream position. Accordingly, the entrance position and entrance angle at which the sheet P enters between the extreme upstream spur wheel 45 and the heat belt 40 in the sheet conveyance direction A do not change, and the entrance of the sheet P may be made reliably.

The present disclosure is applicable but is not limited to the above-described drying device. For example, the present disclosure may be applicable to a drying device having a different configuration.

Next, a description is given of another drying device according to the present disclosure.

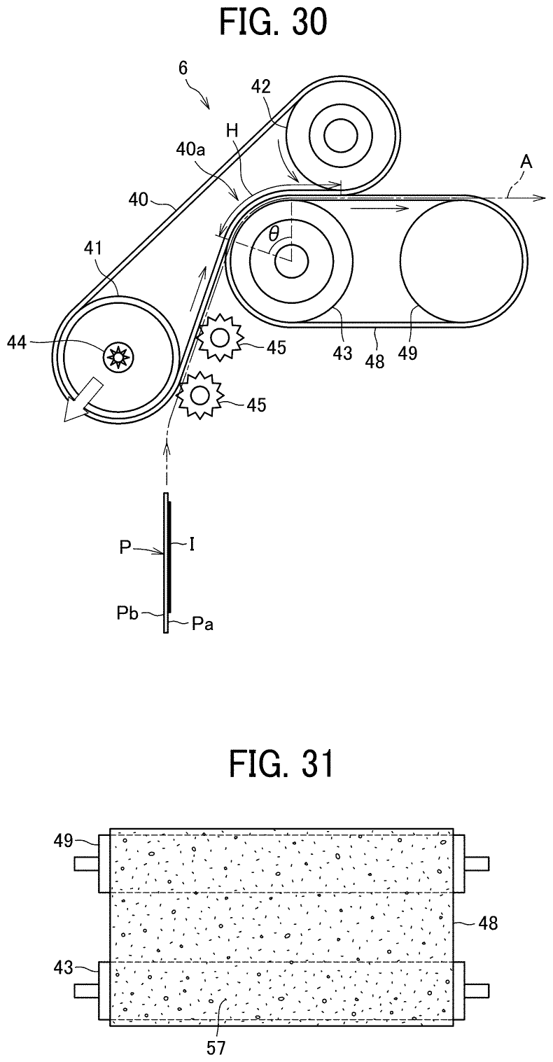

Further, FIG. 30 is a diagram illustrating an example in which the drying device 6 includes a pressure belt 48.

The drying device 6 illustrated in FIG. 30 includes the pressure belt 48. In this example, the pressure belt 48 having an endless loop is wound around the pressure roller 43 and a support roller 49 that is disposed downstream from the pressure roller 43 in the sheet conveyance direction A. The drying device 6 illustrated in FIG. 30 basically has the configuration identical to the configuration of the drying device 6 illustrated in FIG. 4, except the drying device 6 illustrated in FIG. 26 has the pressure belt 48 wound around the pressure roller 43 and the support roller 49.

In the drying device 6 according to FIG. 30, since the pressure roller 43 is biased toward the heat belt 40 via the pressure belt 48, the pressure belt 48 is pressed against the heat belt 40. That is, in the present embodiment, the pressure roller 43 and the pressure belt 48 each of which functions as a pressing member to press the heat belt 40. Further, in the present embodiment, as the fixed roller 42 is driven to rotate, the heat belt 40, the tension roller 41, the pressure belt 48, the pressure roller 43, and the support roller 49 are rotated along with rotation of the fixed roller 42. Further, either the pressure roller 43 or the support roller 49 may function as a drive roller.

In this case, after having passed the spur wheel 45 and then entered between the heat belt 40 and the pressure belt 48, the sheet P is conveyed as the heat belt 40 and the pressure belt 48 rotate while the sheet P is pressed by the heat belt 40 and the pressure belt 48. At this time, the sheet P is warped in the direction opposite the curve direction of the back curl along the curved portion 40a of the heat belt 40. Therefore, generation of back curl is restrained effectively.

Further, the drying device 6 according to the present embodiment employs two belts (the heat belt 40 and pressure belt 48) which are in contact with each other to convey the sheet P. Therefore, the area in which the two belts convey the sheet P while gripping (holding) the sheet P (i.e., the area indicated by H in FIG. 30) extends largely in the sheet conveyance direction A. Accordingly, the sheet P is heated effectively, and the drying of ink on the sheet P is further accelerated and deformation of the sheet P such as back curl is restrained effectively.

In addition, in the drying device 6 according to FIG. 30, the pressure belt 48 is disposed to extend not to the upstream side from the curved portion 40a of the heat belt 40 in the sheet conveyance direction A but to the downstream side from the curved portion 40a of the heat belt 40 in the sheet conveyance direction A. By so doing, the sheet P contacts the heat belt 40 before the sheet P contacts the pressure belt 48, thereby accelerating the drying of ink on the sheet P. Accordingly, the application of ink to the pressure belt 48 is restrained effectively.

FIG. 31 is a diagram illustrating an example that the outer circumferential surface of the pre a pressing belt has fine surface asperities.

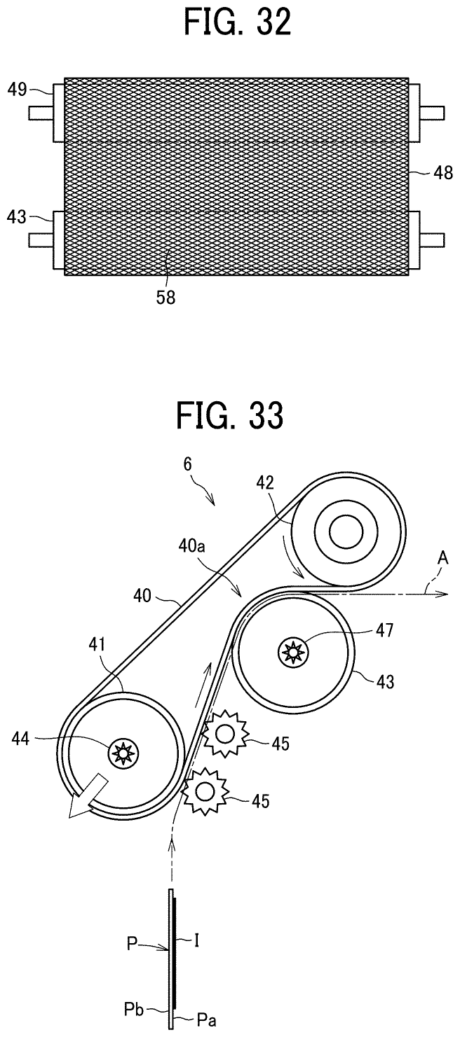

FIG. 32 is a diagram illustrating an example that the pressing belt has a mesh pattern. The pressure belt 48 may include a belt 57 having the uneven outer circumferential surface, in other words, having fine asperities on the outer circumferential surface, as illustrated in FIG. 31, or a belt 58 having a mesh pattern, as illustrated in FIG. 32, may be employed in order to restrain ink application to the pressure belt 48 more effectively.

Further, as the example of FIG. 29, the drying device 6 illustrated in FIG. 30 may allow the pressure roller 43 to move according to the amount of ink application to the sheet P. According to this configuration, the winding angle θ of the heat belt 40 to the pressure belt 48 is changed to change the length H of the contact area in the sheet conveyance direction A in which the pressure belt 48 and the heat belt 40 contact with each other.

FIG. 33 is a diagram illustrating an example of the arrangement in which a heater is disposed inside the pressure roller 43.

The drying device 6 illustrated in FIG. 33 is another example of the drying device 6 illustrated in FIG. 4 further including a heater 47 that functions as a heat source provided inside the pressure roller 43. The drying device 6 illustrated in FIG. 33 basically has the configuration identical to the configuration of the drying device 6 illustrated in FIG. 4, except the drying device 6 illustrated in FIG. 33 has the heater 47 inside the pressure roller 43.

In this case, the pressure roller 43 functions as a pressing member that presses the sheet P and as a heating member (heat rotator) that heats the sheet P. Therefore, when the sheet P passes the pressure roller 43, the sheet P is heated from the face that contacts the heat belt 40 (i.e., the opposite face Pb opposite the liquid applied face Pa) and the face that contacts the pressure roller 43 (i.e., the liquid applied face Pa) at the same time. Accordingly, the sheet P is heated effectively, and the drying of ink on the sheet P is further accelerated.

Further, in this case, the heat is applied to the face that contacts the heat belt 40 (i.e., the opposite face Pb opposite the liquid applied face Pa) longer than the face that contacts the pressure roller 43 (i.e., the liquid applied face Pa). Therefore, as the above-described embodiment, the opposite face Pb opposite the liquid applied face Pa of the sheet P is heated at the temperature higher than the temperature to the liquid applied face Pa. Accordingly, in this example, the force is exerted in the opposite direction opposite the force to generate a back curl on the sheet P, thereby restraining generation of the back curl. Further, in the configuration in which such a sheet P is heated from both sides (i.e., both the front and back faces), heat generation by the heater 44 and the heater 47 may be controlled in order to restrain generation of back curl more reliably.

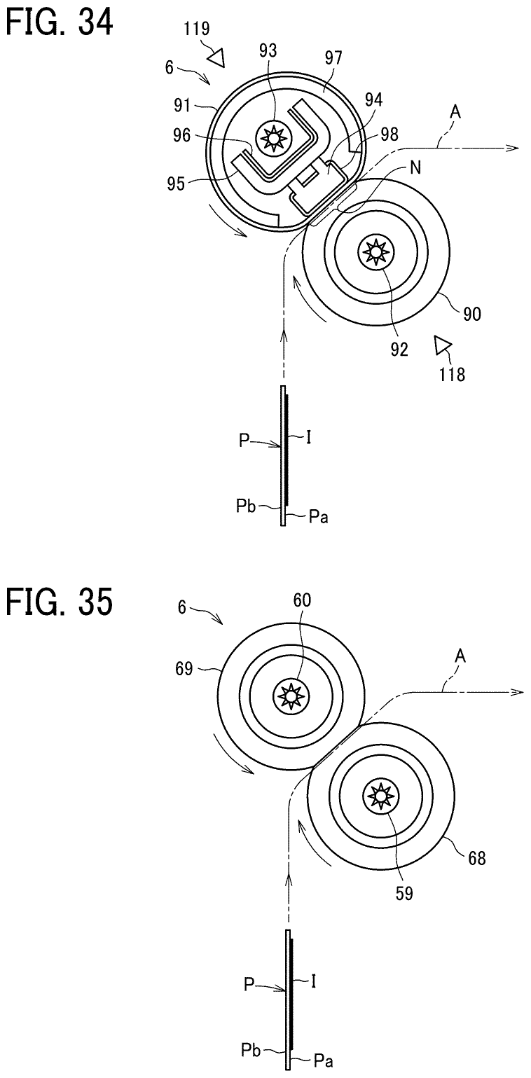

FIG. 34 is a diagram illustrating an example of controlling heat generation in each heater so that the opposite face Pb that is opposite the liquid applied face Pa of the sheet P is heated at the higher temperature.

The drying device 6 illustrated in FIG. 34 is an example that, by controlling heat generation in heaters 92 and 93, the opposite face Pb of the sheet P is heated at the temperature higher than the liquid applied face Pa of the sheet P.

To be more specific, the drying device 6 illustrated in FIG. 34 includes a heat roller 90, a heat belt 91, the heaters 92 and 93, a nip formation pad 94, a stay 95, a reflector 96, a belt support 97, and two temperature sensors 118 and 119.

The heat roller 90 functions a first heating member that heats the sheet P and is a cylindrical heat rotator. On the other hand, the heat belt 91 having an endless loop functions as a second heating member that heats the sheet P and is a cylindrical heat rotator that is a belt member radially thinner than the heat roller 90.

The heat roller 90 is biased by a pressing member such as a spring or a cam and is pressed against the nip formation pad 94 via the heat belt 91. Accordingly, the heat roller 90 is pressed against the heat belt 91, so that the nip region N is formed between the heat roller 90 and the heat belt 91. The nip formation pad 94 is preferably made of a heat-resistant resin material such as liquid crystal polymer (LCP) in order to prevent deformation due to application of heat and to form the nip region N having the stability.

Of the two heaters 92 and 93, the heater 92 is disposed inside the heat roller 90 and the heater 93 is disposed inside the heat belt 91. In the present embodiment, the heaters 92 and 93 each employs a halogen heater. A heat source included in the drying device 6 may be a radiant-heat-type heater that emits infrared rays such as a halogen heater or a carbon heater, or an electromagnetic-induction-type heat source.

In the present embodiment, in order to improve the slidability of the heat belt 91 with respect to the nip formation pad 94, a sheet-like sliding member (sliding sheet) 98 made of a low friction material such as PTFE is provided between the nip formation pad 94 and the heat belt 91. Further, in a case in which the nip formation pad 94 is made of a low friction material having slidability, the nip formation pad 94 may come into direct contact with the heat belt 91 without interposing the sliding member 98.

The stay 95 is a support that supports the nip formation pad 94 against the pressing force of the heat roller 90. Since the stay 95 supports the nip formation pad 94, the bending of the nip formation pad 94 is restrained, thereby forming the nip region N having the uniform width. Further, the stay 95 is preferably made of metal material such as SUS or SECC in order to have the good rigidity.

The reflector 96 reflects heat and light radiated from the heater. The reflector 96 is interposed between the heater 93 in the heat belt 91 and the stay 95 in the loop of the heat belt 91, so as to reflect the heat and light radiated from the heater 93 in the heat belt 91. Since the heat belt 91 receives light reflected by the reflector 96 in addition to light directly radiated from the heater 93. Therefore, the heat belt 91 is heated effectively. Further, since the reflector 96 restrains heat transmission to a member, e.g., the stay 95, other than the heat belt 91, the energy-saving performance is enhanced. The reflector 96 is made of, e.g., aluminum or stainless steel.

The belt support 97 is a C-shaped or cylindrical member that supports the heat belt 91 from the inside. The belt support 97 is provided inside the heat belt 91, at both ends of the heat belt 91 in the rotational axis direction. With this configuration, the belt support 97 rotatably supports the heat belt 91. In particular, in the stationary state in which the heat belt 91 is not rotating, the heat belt 91 is basically supported in a state in which the tension is not generated in the circumferential direction of the heat belt 91.

Further, the temperature sensor 118 functions as a temperature detector to detect the surface temperature of the heat roller 90, in other words, the temperature of the outer circumferential surface of the heat roller 90. Similarly, the temperature sensor 119 functions as a temperature detector to detect the surface temperature of the heat belt 91, in other words, the temperature of the outer circumferential surface of the heat belt 91. The amount of heat generation of the heater 92 and the amount of heat generation of the heater 93 are controlled based on the temperatures detected by the temperature sensors 118 and 119, respectively, to make the surface temperature of the heat belt 91 to be higher than the surface temperature of the heat roller 90. Note that the positions of the temperature sensors 118 and 119 are not limited to the positions in FIG. 34 but may be respective positions near the nip start position of the heat roller 90 and the heat belt 91 (e.g., the entrance side of the sheet P to the nip region N). Further, respective temperature detectors may be detected to directly detect the temperatures of the heaters 92 and 93, so as to control the surface temperature of the heat belt 91 to be higher than the surface temperature of the heat roller 90 based on the temperatures detected by the temperature detectors.

In the drying device 6 illustrated in FIG. 34, as the heat roller 90 is driven to rotate in the direction indicated by arrow in FIG. 34 (i.e., the clockwise direction), the heat belt 91 is rotated along with rotation of the heat roller 90. Further, as the heaters 92 and 93 start to generate heat, the heat roller 90 and the heat belt 91 are heated. At this time, the amounts of heat generation of the heaters 92 and 93 are controlled based on the temperatures detected by the temperature sensors 118 and 119, respectively, to make the surface temperature of the heat belt 91 to be higher than the surface temperature of the heat roller 90.

In the state under the thus controlled temperature, as the sheet P is conveyed to the drying device 6, the opposite face Pb of the sheet P that is opposite the liquid applied face Pa of the sheet P is heated by the heat belt 91 having the higher surface temperature. As a result, the opposite face Pb of the sheet P is heated at the temperature higher than the temperature of the liquid applied face Pa of the sheet P. Therefore, a force is exerted in the opposite direction to a force applied to the sheet P to generate the back curl. As described above, in the drying device 6 illustrated in FIG. 34, the amounts of heat generation of the heaters 92 and 93 are controlled. By so doing, the state in which the opposite face Pb of the sheet P is heated at the temperature higher than the liquid applied face Pa of the sheet P is achieved reliably, thereby restraining generation of back curl on the sheet P more effectively.

Further, FIG. 35 is a diagram illustrating an example in which a first heating member and a second heating member are heat rollers constructing a pair of heat rollers.

As illustrated in FIG. 35, the first heating member and the second heating member each heating the sheet P may be heat rollers 68 and 69. The heat rollers 68 and 69 contact (press) each other as a pair of heat rollers and have heaters 59 and 60 inside, respectively.

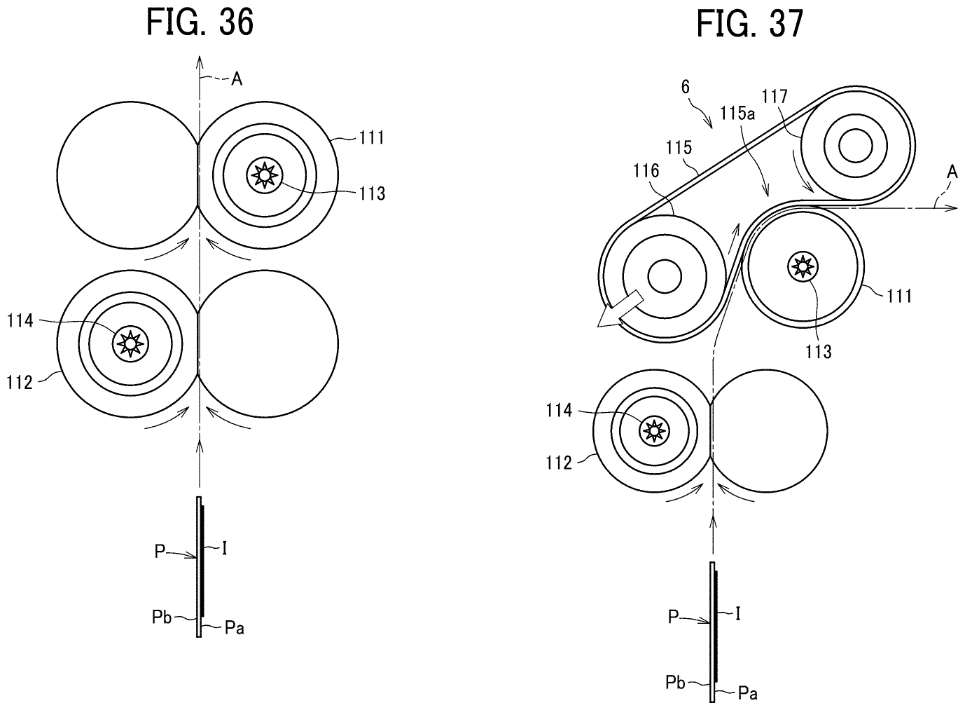

FIG. 36 is a diagram illustrating an example in which the first heating member and the second heating member do not contact with each other.

As the example illustrated in FIG. 36, the first heating member and the second heating member may not be disposed to contact with each other. In this example, a first heat roller 111 that functions as a first heating member having a heater 113 inside and a second heat roller 112 that functions as a second heating member having a heater 114 inside may be disposed at respective positions apart from each other in the sheet conveyance direction A so as not to contact with each other. In this case, in order that the opposite face Pb of the sheet P that is opposite the liquid applied face Pa of the sheet P is heated at the temperature higher than the liquid applied face Pa of the sheet P, the surface temperature of the second heat roller 112 is controlled to be higher than the surface temperature of the first heat roller 111.

However, in this case, in controlling the surface temperature of the second heat roller 112 to be higher than the surface temperature of the first heat roller 111, it is preferable to control the surface temperature in consideration of the following circumstances. That is, in the example illustrated in FIG. 36, after the sheet P has passed through the nip region of the second heat roller 112, the surface temperature of the sheet P decreases before the sheet P enters the nip region of the first heat roller 111. Therefore, the first heat roller 111 may need to heat the sheet P after the entrance of the sheet P to the nip region of the first heat roller 111, so that the temperature of the liquid applied face Pa of the sheet P does not become higher than the temperature of the opposite face Pb that is opposite the liquid applied face Pa of the sheet P. Therefore, it is preferable to control the temperature of the first heat roller 111 to be lower than the temperature of the opposite face Pb that is opposite the liquid applied face Pa of the sheet P when the sheet P enters the nip region of the first heat roller 111. By thus controlling the temperature of the first heat roller 111, the temperature of the opposite face Pb of the sheet P that is opposite the of the sheet P is maintained to be higher than the temperature of the liquid applied face Pa of the sheet P, so that back curl is restrained effectively.

FIG. 37 is a diagram illustrating an example that a rotary body that contacts the first heat roller 111 is a belt.

To be more specific, the roller that contacts the first heat roller 111 in the example illustrated in FIG. 36 may be replaced to a belt 115 having an endless loop as illustrated in FIG. 37. The belt 115 illustrated in FIG. 37 is wound with tension by two support rollers 116 and 117. Since the first heat roller 111 is pressed against the belt 115, the belt 115 has a curved portion 115a that curves along the outer circumferential surface of the first heat roller 111.

In this case, the opposite face Pb of the sheet P is heated at the temperature higher than the liquid applied face Pa of the sheet P and the decurling action is performed on the sheet P when the sheet P passes along the curved portion 115a of the belt 115. Therefore, generation of the back curl is restrained effectively.

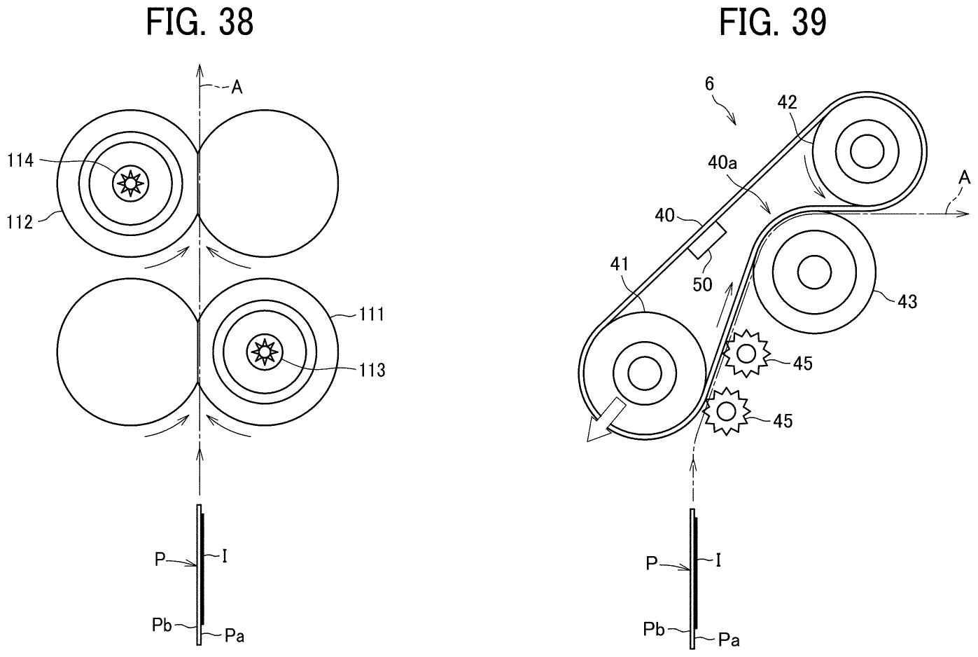

FIG. 38 is a diagram illustrating an example in which the order of the position of the first heat roller 111 and the position of the second heat roller 112 in the sheet conveyance direction A are reversed from the order of the positions illustrated in FIG. 36.

As illustrated in FIG. 38, the order of the position of the first heat roller 111 and the position of the second heat roller 112 illustrated in FIG. 38 may be reversed from the order of the positions illustrated in FIG. 36, over the sheet conveyance direction A. That is, the first heat roller 111 may be disposed upstream from the second heat roller 112 in the sheet conveyance direction A. In this case, the sheet P first contacts the first heat roller 111, so that the liquid applied face Pa of the sheet P is heated. Then, as the sheet P contacts the second heat roller 112, the opposite face Pb that is opposite the liquid applied face Pa of the sheet P is heated. At this time, since the temperature of the second heat roller 112 is set to be higher than the temperature of the first heat roller 111, after the liquid applied face Pa of the sheet P is heated by the first heat roller 111, the opposite face Pb of the sheet P is heated by the second heat roller 112 at the higher temperature. Accordingly, the force is exerted in the opposite direction opposite the direction of the force to generate a back curl on the sheet P, thereby restraining generation of a back curl.

Further, FIG. 39 is a diagram illustrating an example that a ceramic heater is employed to contact the heat belt.

The heater to heat the heat belt 40 illustrated in FIG. 4 and FIGS. 25 through 33 is not limited to the heater provided inside a roller but may be a ceramic heater 50 that contacts the inner circumferential surface of the heat belt 40 as illustrated in FIG. 39, for example.

Further, the ceramic heater 50 may be disposed in contact with the outer circumferential surface of the heat belt 40. However, since the ceramic heater 50 relatively slides on the heat belt 40 while the heat belt 40 is rotating, in order to reduce the sliding resistance at this time, it is preferable that a slide sheet including a low friction material or a sheet metal such as aluminum having a slide coating to enhance the thermal conductivity efficiency may be inserted between the ceramic heater 50 and the heat belt 40.

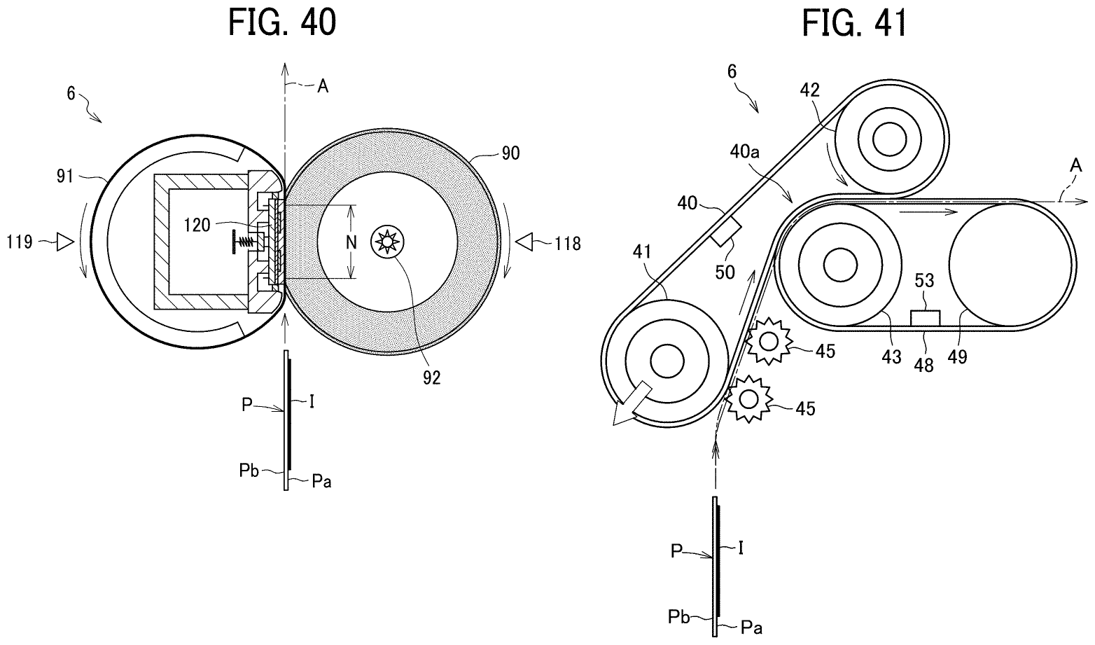

Further, FIG. 40 is a diagram illustrating an example that a ceramic heater is employed to contact the heat belt at the nip region.

As illustrated in FIG. 40, the heat source may be a ceramic heater 120 that contacts the heat belt 91 at the nip region N.

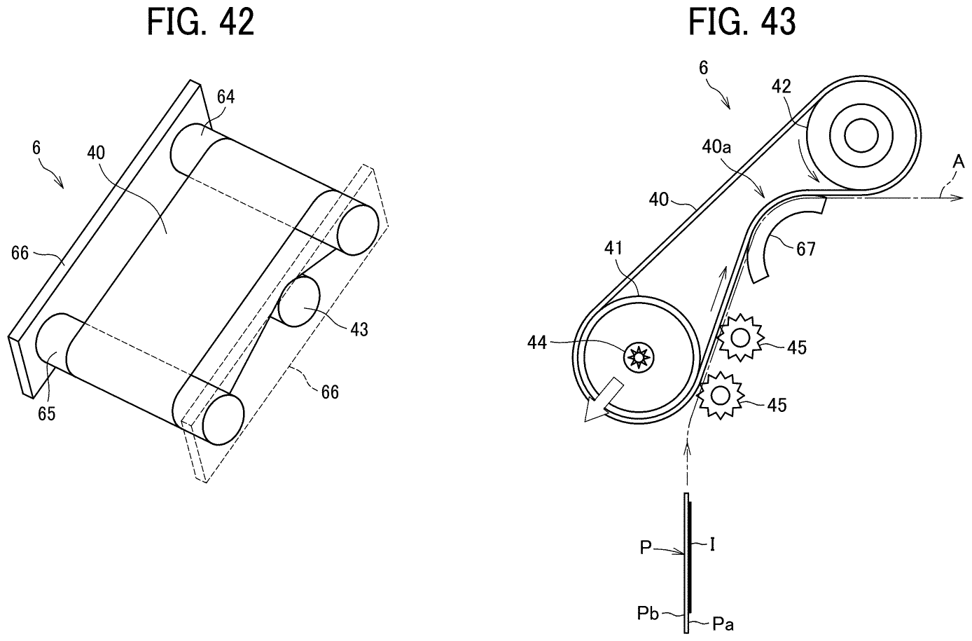

Furthermore, FIG. 41 is a diagram illustrating an example that a ceramic heater is employed to contact the pressure belt.

As illustrated in FIG. 41, a ceramic heater 53 that contacts the pressure belt 48 may be employed in addition to the ceramic heater 50 that contacts the heat belt 40.

Further, FIG. 42 is a diagram illustrating an example that the heat belt is supported by a belt support that does not rotate.

The belt support that supports the heat belt 40 is not limited to a rotary body such as a roller and a belt. For example, as illustrated in FIG. 42, the heat belt 40 may be supported by a plurality of belt supports, which are a belt support 64 and a belt support 65. The belt supports 64 and 65 do not rotate. Further, each of the belt supports 64 and 65 may be constructed as separate parts or may be constructed as a single unit via a pair of frame members 66. In this case, as the pressure roller 43 is driven to rotate, the heat belt 40 is rotated along with rotation of the pressure roller 43 while sliding on the belt supports 64 and 65. At this time, it is preferable that each of the belt supports 64 and 65 includes a low friction material in order to reduce this sliding resistance between the heat belt 40 and each of the belt supports 64 and 65. Alternatively, a slide sheet that includes a low friction material may be provided between the heat belt 40 and the belt support 64 and between the heat belt 40 and the belt support 65.

Further, FIG. 43 is a diagram illustrating an example that the drying device 6 employs a pressing pad that does not rotate.

In the drying device (heating device) according to the present disclosure, the pressing member that presses the heat belt 40 to form the curved portion is not limited to a rotary body such as a pressure roller. For example, as the example illustrated in FIG. 43, the pressing member may be a pressing pad 67 that does not rotate and includes a ceramic heater having a curved surface. For example, in a case in which the liquid to be applied to the sheet is a processing liquid that does not form an image, even if the pressing pad 67 slides on the liquid applied face Pa of the sheet P, no problem of smear of the image does not occur. Therefore, the pressing pad 67 may be employed. Note that, also in this case, it is preferable to insert a slide sheet that includes a low friction material, between the heat belt 40 and the pressing pad 67, in order to reduce the sliding resistance that is generated between the heat belt 40 and the pressing pad 67.

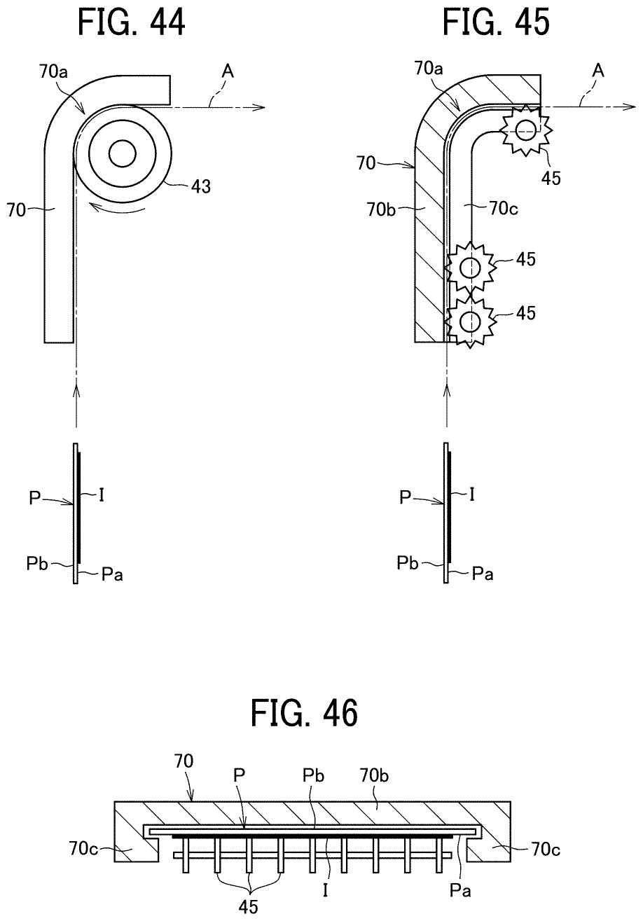

Further, FIG. 44 is a diagram illustrating an example in which the drying device 6 includes a heat guide.

As illustrated in FIG. 44, instead of a rotary body such as the heat belt 40, a heat guide 70 that does not rotate may be employed. The heat guide 70 illustrated in FIG. 44 includes a curved portion 70a that warps the sheet P. As the pressure roller 43 rotates, the sheet P is conveyed while contacting the heat guide 70. At this time, the sheet P is heated by the heat guide 70 from the opposite face Pb that is opposite the liquid applied face Pa of the sheet P and is conveyed while being warped so that the liquid applied face Pa forms a concave shape when the sheet P passes the curved portion 70a of the heat guide 70, thereby restraining generation of back curl.

Further, FIG. 45 is a diagram illustrating a heat guide 70 according to a variation.

FIG. 46 is a cross sectional view illustrating the heat guide 70 of FIG. 45 in the width direction of the sheet.

The heat guide 70 may have a configuration illustrated in FIG. 45 or a configuration illustrated in FIG. 46. In this case, the heat guide 70 includes a main guide portion 70b and a pair of end guide portions 70c. The main guide portion 70b is disposed over the entire width direction of the sheet P. The end guide portions 70c are disposed at both lateral ends of the sheet P (both ends in the width direction of the sheet P). The main guide portion 70b is disposed facing the opposite face Pb that is opposite the liquid applied face Pa of the sheet P.

Each of the pair of end guide portions 70c is disposed facing the corresponding lateral end of the sheet P (the corresponding end of the sheet P in the width direction) and the liquid applied face Pa at the corresponding lateral end of the sheet P. Further, in this case, the pressure roller 43 is not provided on the curved portion 70a of the heat guide 70. Instead of the pressure roller 43, the spur wheels 45 are provided upstream and downstream from the heat guide 70 in the sheet conveyance direction A.

In the embodiment illustrated in FIGS. 45 and 46, as the sheet P is conveyed to the heat guide 70, both ends in the width direction of the sheet P enter between the main guide portion 70b and each end guide portion 70c, so that the sheet P is guided by the main guide portion 70b and the end guide portions 70c. Further, the sheet P is conveyed while being held by the main guide portion 70b and the spur wheel 45 on the upstream side in the sheet conveyance direction A. Then, the sheet P passes the curved portion 70a of the heat guide 70. Thereafter, the sheet P is held and conveyed by the main guide portion 70b and the spur wheel 45 on the downstream side in the sheet conveyance direction A, and eventually the sheet is ejected. Also, in this case, the sheet P is heated from the opposite face Pb opposite the liquid applied face Pa and is warped so that the liquid applied face Pa is formed in a concave shape. By so doing, the deformation of the sheet P such as back curl is restrained effectively.

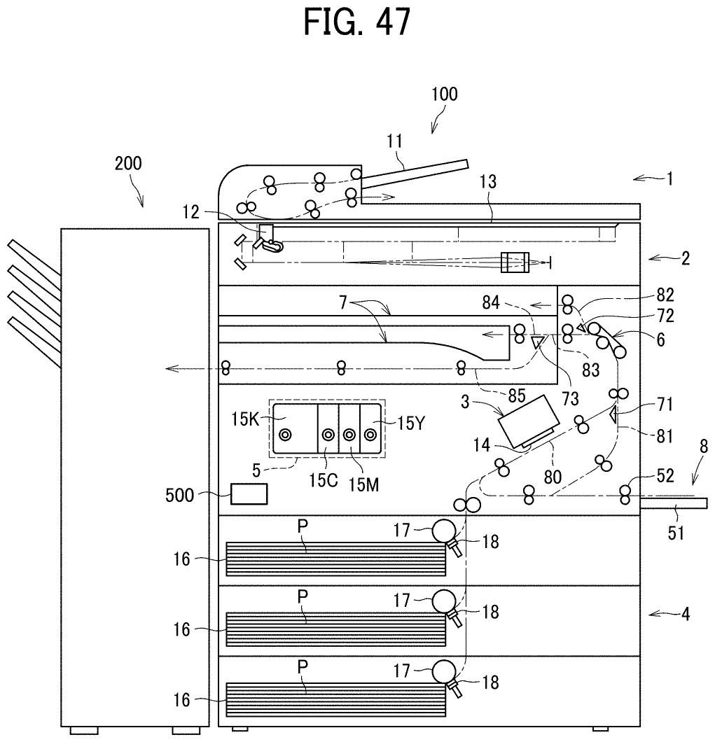

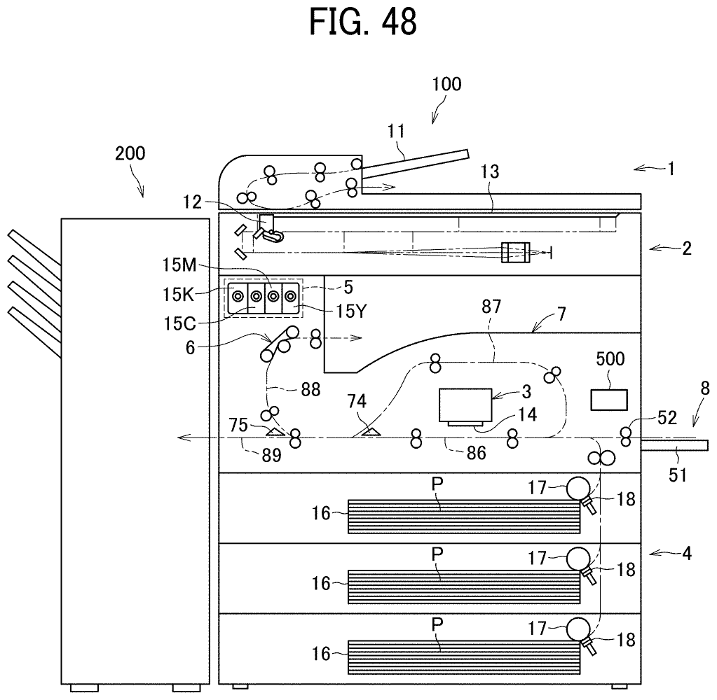

As described above, various types of configurations of the drying devices each applicable to the present disclosure have been described. However, the drying device (heating device) according to the present disclosure is not limited to the image forming apparatus having the configuration as illustrated in FIG. 1 but may be applied to the image forming apparatus having the configuration as illustrated in FIG. 47 or the image forming apparatus having the configuration as illustrated in FIG. 48.

Next, a description is given of the configuration of the image forming apparatus 100 with reference to FIGS. 47 and 48.

FIG. 47 is a diagram illustrating the configuration of another image forming apparatus.

FIG. 48 is a diagram illustrating the configuration of yet another image forming apparatus.

Note that the following description is given of the configuration of the image forming apparatus 100 illustrated in FIGS. 47 and 48 different from the configuration of the above-described image forming apparatus 100. That is, the description of the configuration of the image forming apparatus 100 of FIGS. 47 and 48 that is same as the configuration of the image forming apparatus 100 according to the above-described embodiment, for example, the image forming apparatus 100 illustrated in FIG. 1, may be omitted.

Similar to the image forming apparatus 100 according to the above-described embodiments, the image forming apparatus 100 illustrated in FIG. 47 includes the original document conveying device 1, the image reading device 2, the image forming device 3, the sheet feeding device 4, the cartridge container 5, the drying device (heating device) 6, and the sheet ejection portion 7.

Different from the image forming apparatus 100 according to the above-described embodiments, the image forming apparatus 100 illustrated in FIG. 47 further includes a bypass sheet feeding device 8. Different from the image forming device 3 in FIG. 1, the image forming device 3 in FIG. 47 is disposed facing a sheet conveyance passage 80 in which the sheet P is conveyed in a direction obliquely to the horizontal direction.

The bypass sheet feeding device 8 includes a bypass tray 51 and a bypass sheet feed roller 52. The bypass tray 51 functions as a sheet loader to load the sheet P. The bypass sheet feed roller 52 functions as a sheet feed body to feed the sheet P from the bypass tray 51. The bypass tray 51 is attached to open and close with respect to the housing of the image forming apparatus 100. In other words, the bypass tray 51 is rotatably attached to the housing of the image forming apparatus 100. When the bypass tray 51 is open (state in FIG. 47), the sheet P or the bundle of sheets including the sheet P is loaded on the bypass tray 51 to feed the sheet P to the housing of the image forming apparatus 100.

In the image forming apparatus 100 illustrated in FIG. 47, as a print job start instruction is issued, the sheet P is supplied from the sheet feeding device 4 or from the bypass sheet feeding device 8 and is conveyed to the image forming device 3. Then, when the sheet P is conveyed to the image forming device 3, ink is discharged from the liquid discharge head 14 onto the sheet P to form an image on the sheet P.

When performing the duplex printing, after the sheet P has passed the image forming device 3, the sheet P is then conveyed in the opposite direction opposite the sheet conveyance direction. Then, a first passage changer 71 guides the sheet P to a sheet reverse passage 81. Then, as the sheet P passes the sheet reverse passage 81, the sheet P is reversed from the front face to the back face, and then is conveyed to the image forming device 3 again to form an image on the back face of the sheet P.

The sheet P having the image on one side or both sides is conveyed to the drying device 6 in which the ink on the sheet P is dried. Note that it is preferable that, when drying the ink on the front face of the sheet P and then forming an image on the back face of the sheet P, the drying device 6 dries the ink on the front face of the sheet P first, and then, the sheet P is conveyed in a sheet conveyance passage that detours the drying device 6. Then, it is also preferable that the direction of conveyance of the sheet P is switched back (changed) to the upstream side from the drying device 6 in the sheet conveyance direction, and the sheet P is guided to the image forming device 3 again via the sheet reverse passage 81. After the sheet P has passed the drying device 6, a second passage changer 72 guides the sheet P selectively to a sheet conveyance passage 82 that runs toward the upper sheet ejection portion 7 or to a sheet conveyance passage 83 that runs to the lower sheet ejection portion 7. In a case in which the sheet P is guided to the sheet conveyance passage 82 toward the upper sheet ejection portion 7, the sheet P is ejected to the upper sheet ejection portion 7. On the other hand, when the sheet P is guided to the sheet conveyance passage 83 toward the lower sheet ejection portion 7, a third passage changer 73 guides the sheet P selectively to a sheet conveyance passage 84 toward the lower sheet ejection portion 7 or to a sheet conveyance passage 85 toward the sheet alignment apparatus 200.

Then, when the sheet P is guided to the sheet conveyance passage 84 toward the lower sheet ejection portion 7, the sheet P is ejected to the lower sheet ejection portion 7. On the other hand, when the sheet P is guided to the sheet conveyance passage 85 toward the sheet alignment apparatus 200, the sheet is conveyed to the sheet alignment apparatus 200, so that the bundle of sheets P is aligned and stacked.

Then, as in the image forming apparatus 100 illustrated in FIG. 47, the image forming apparatus 100 illustrated in FIG. 48 includes the original document conveying device 1, the image reading device 2, the image forming device 3, the sheet feeding device 4, the cartridge container 5, the drying device (heating device) 6, the sheet ejection portion 7, and the bypass sheet feeding device 8. Note that, in this case, similar to the image forming device 3 included in the image forming apparatus 100 in FIG. 1, the image forming device 3 included in the image forming apparatus 100 illustrated in FIG. 48 is disposed facing a sheet conveyance passage 86 in which the sheet P is conveyed in the horizontal direction.

In the image forming apparatus 100 illustrated in FIG. 48, as a print job start instruction is issued, the sheet P is supplied from the sheet feeding device 4 or from the bypass sheet feeding device 8 and is conveyed to the image forming device 3. Then, when the sheet P is conveyed to the image forming device 3, ink is discharged from the liquid discharge head 14 onto the sheet P to form an image on the sheet P.

When performing the duplex printing, after the sheet P has passed the image forming device 3, the sheet P is then conveyed in the opposite direction opposite the sheet conveyance direction. Then, a first passage changer 74 guides the sheet P to a sheet reverse passage 87. Then, as the sheet P passes the sheet reverse passage 87, the sheet P is reversed from the front face to the back face and is conveyed to the image forming device 3 again, so that an image is formed on the back face of the sheet P.

After an image is formed on one side or both sides of the sheet P, a second passage changer 75 guides the sheet P selectively to a sheet conveyance passage 88 that runs toward the drying device 6 or to a sheet conveyance passage 89 that runs to the sheet alignment apparatus 200. When the sheet P is guided to the sheet conveyance passage 88 toward the drying device 6, the drying device 6 dries the ink on the sheet P. Note that, when drying the ink on the front face of the sheet P and then forming an image on the back face of the sheet P, it is preferable that, after the drying device 6 has dried the ink on the front face of the sheet P first, the sheet P is conveyed in a sheet conveyance passage that detours the drying device 6. Then, it is also preferable that the direction of conveyance of the sheet P is switched back (changed) to the upstream side from the sheet conveyance passage 88 (upstream sides from the drying device 6) in the sheet conveyance direction, and the sheet P is guided to the image forming device 3 again via the sheet reverse passage 87. Consequently, the sheet P that has passed the drying device 6 is ejected to the sheet ejection portion 7. On the other hand, when the sheet P is guided to the sheet conveyance passage 89 toward the sheet alignment apparatus 200, the sheet P is conveyed to the sheet alignment apparatus 200, so that the bundle of sheets P is aligned and stacked.

Further, the drying device 6 according to the above-described embodiments of the present disclosure may be provided directly to the image forming apparatus 100 or may be provided in an additional processing device that is attached to the image forming apparatus 100.

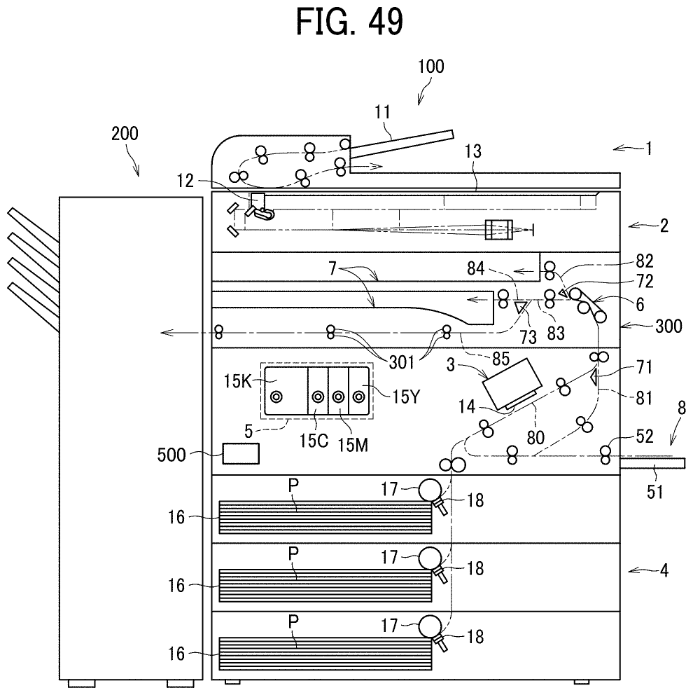

FIG. 49 is a diagram illustrating an example of an additional processing device included in an image forming apparatus.

For example, as an example of an additional processing device, the drying device 6 according to the above-described embodiments may be applied to a conveying device 300 illustrated in FIG. 49. The conveying device 300 is detachably attached to the image forming apparatus 100. The conveying device 300 includes a plurality of sheet conveying rollers 301 each functioning as a conveying device that conveys the sheet, the sheet conveyance passages 82 to 85 through which the sheet passes, the drying device 6 to heat the sheet, and the sheet ejection portion 7 to which the sheet is ejected. The conveying device 300 is detachably attached between the image reading device 2 and the image forming device 3. Further, the conveying device 300 conveys the sheet to a post-processing apparatus (for example, the sheet alignment apparatus 200) that performs a certain process to the sheet that has passed the drying device 6. By providing the drying device (heating device) according to any of the above-described embodiments to the conveying device 300 that is detachably attached to the image forming apparatus 100, even if deformation of the sheet such as a curl occurs in the image forming apparatus 100, the drying device 6 provided in the conveying device 300 restrains the deformation of the sheet effectively.

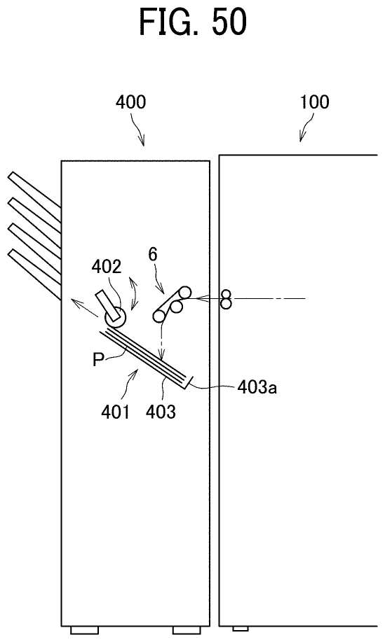

FIG. 50 is a diagram illustrating another example of an additional processing apparatus attached to the image forming apparatus 100.

The drying device according to the above-described embodiments of the present disclosure is applied to a post-processing apparatus 400, as illustrated in FIG. 50. As illustrated in FIG. 50, the post-processing apparatus 400 is detachably attached to the housing of the image forming apparatus 100. The post-processing apparatus 400 may be included in the image forming apparatus 100. The post-processing apparatus 400 includes the drying device 6 that heats the sheet and a post-processing device 401 that performs a stapling process and a punching process to the sheet conveyed from the drying device 6.

As the sheet is conveyed from the image forming apparatus 100 to the post-processing apparatus 400 illustrated in FIG. 50, the sheet is heated by the drying device 6 and is loaded on a sheet stacking tray 403 of the post-processing device 401. At this time, in a case in which the sheet is stacked in the sheet stacking tray 403 with the face up (with the image forming surface facing up), the order of image formation may be set to be reversed, in other words, the image may be formed from the last page first. Further, the sheet P stacked on the sheet stacking tray 403 is conveyed by a sheet conveying roller 402 provided in the post-processing device 401 in the reverse direction with the trailing end of the sheet P to the leading end of the sheet P. By so doing, the trailing end of the sheet P contacts a trailing end regulator 403a of the sheet stacking tray 403, so that the position of the trailing end of the sheet P is aligned. Further, in order not to hinder ejection of the sheet to the sheet stacking tray 403, the sheet conveying roller 402 is disposed to be movable from a position at which the sheet conveying roller 402 contacts the sheet P to a retreat position at which the sheet conveying roller 402 does not contact the sheet P. In the state in which the position of the trailing end of the sheet P is aligned, the stapling process and the punching process are performed to the sheet P. Thereafter, the sheet conveying roller 402 rotates in the reverse direction, and therefore the sheet P on the sheet stacking tray 403 is ejected to the outside of the post-processing apparatus 400. As the drying device (heating device) according to any of the above-described embodiments is provided to the post-processing apparatus 400 described above, even if the image forming apparatus 100 generates deformation of the sheet such as a curl, the drying device 6 provided in the post-processing apparatus 400 restrains the deformation of the sheet effectively.

As described above, the drying device to which the present disclosure is applicable and various devices in which the drying device is provided have been explained. However, similar to the above-described embodiments, in these embodiments, after the image forming device 3 applies the ink (liquid) to the sheet P, the speed of the sheet P is increased to convey the drying device 6. By so doing, the productivity of the image forming apparatus 100 is enhanced.

Further, the drying device (heating device) according to the present disclosure is not limited to a heating device that heats a sheet while holding the sheet. For example, as a heat source of the heating device, a radiation-type heater, e.g., a halogen heater and a carbon heater, to emit infrared ray, and an electromagnetic induction-type heat source may be employed. Further, the heat source may be a contact-type heater or a non-contact type heater.

Further, the conveyance target object applicable to the present disclosure is not limited to a sheet such as paper sheet, resin, cloth, or leather. For example, the conveyance target object may be a planar member including ceramics, glass, wood, or metal, corrugated cardboard, or gypsum board.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An image forming apparatus comprising:
a liquid applier configured to apply liquid to a conveyance target object that is conveyed at a first speed;
a heating device configured to heat the conveyance target object on which the liquid is applied; and
circuitry configured to control a conveying speed of the conveyance target object,
the circuitry being configured to cause the conveyance target object to be conveyed at a second speed that is faster than the first speed after the liquid applier applies the liquid to the conveyance target object.

2. The image forming apparatus according to claim 1,
wherein the circuitry is configured to cause the conveyance target object to pass the heating device at a third speed that is slower than the second speed.

3. The image forming apparatus according to claim 2,
wherein the third speed is slower than the first speed.

4. The image forming apparatus according to claim 2,
wherein the circuitry is configured to decrease the conveying speed from the second speed to the third speed and cause the conveyance target object to enter the heating device.

5. The image forming apparatus according to claim 2,
wherein the circuitry is configured to change at least one of the second speed and the third speed according to an interval between the conveyance target object and another conveyance target object subsequent to the conveyance target object in a conveyance direction of the conveyance target object and said another conveyance target object.

6. The image forming apparatus according to claim 2,
wherein the circuitry is configured to change at least one of a timing to change the conveying speed from the first speed to the second speed and a timing to change the conveying speed from the second speed to the third speed, according to an interval between the conveyance target object and another conveyance target object subsequent to the conveyance target object in a conveyance direction of the conveyance target object and said another conveyance target object.

7. The image forming apparatus according to claim 1,
wherein the circuitry is configured to change the conveying speed when the conveyance target object passes the heating device according to an amount of the liquid applied to the conveyance target object.

8. The image forming apparatus according to claim 1, further comprising a detector configured to detect the conveyance target object on which the liquid is applied,
wherein the circuitry is configured to change the conveying speed of the conveyance target object from the first speed to the second speed based on a detection timing of the detector.

9. The image forming apparatus according to claim 1, further comprising a reverse passage through which the conveyance target object, on which the liquid is applied, is reversed upside down and conveyed not to the heating device but to the liquid applier again,
wherein the circuitry is configured to:
convey the conveyance target object to the reverse passage at the second speed that is faster than the first speed after the liquid applier applies the liquid to one face of the conveyance target object; and
convey the conveyance target object to the heating device at the second speed that is faster than the first speed after the liquid applier applies the liquid to another face of the conveyance target object opposite the one face.

10. The image forming apparatus according to claim 1, further comprising a post-processing apparatus configured to perform a post-processing operation to the conveyance target object after the conveyance target object has passed the heating device.

11. The image forming apparatus according to claim 10,
wherein the post-processing apparatus includes the heating device, and
wherein the post-processing apparatus is detachably attached to a housing of the image forming apparatus including the liquid applier.

12. The image forming apparatus according to claim 1, further comprising a conveying device configured to convey the conveyance target object to a post-processing apparatus configured to perform a post-processing operation to the conveyance target object,
wherein the conveying device includes the heating device, and
wherein the conveying device is detachably attached to a housing of the image forming apparatus including the liquid applier.
